(19) United States
(12) Patent Application Publication
(10) Pub. No.: US 2026/0045011 A1
(43) Pub. Date: Feb. 12, 2026

(54) GENERATING AND UPDATING WORKFLOW OUTLINES USING AN ARTIFICIAL INTELLIGENCE ASSISTANT

(71) Applicant: Workato, Inc., Palo Alto, CA (US)

(72) Inventors: Mark Poroshin, Tbilisi (GE); Ming Xu Bennett Goh, Singapore (SG)

(21) Appl. No.: 19/296,771

(22) Filed: Aug. 11, 2025

Related U.S. Application Data
(60) Provisional application No. 63/681,724, filed on Aug. 9, 2024.

(51) Int. Cl. G06T 11/60; G06F 9/451; G06F 40/30

(52) U.S. Cl. CPC G06T 11/60; G06F 9/451; G06F 40/30

(57) ABSTRACT

A system may receive a user prompt in a conversational interface and may determine an intent of a user using one or more artificial intelligence (“AI”) models. The system may generate a recipe sketch including a set of rough automated operations configured to accomplish a task, and it may provide a graphical user interface displaying the recipe sketch to the user. The system may receive a user input modifying the recipe sketch and, using the one or more AI models, modify the recipe sketch, and it may display the modified recipe sketch in the graphical user interface. The system may use the modified recipe sketch with the one or more AI models to generate a full, solved recipe, such as a set of executable operations to accomplish the task. In some cases, the graphical user interface may be updated to illustrate the generated set of executable operations.

### BACKGROUND

The present disclosure relates to a platform for improving the generation of automated workflows or code. For instance, the disclosure relates to a system and method for generating and updating workflow outlines using an artificial intelligence (AI) agent.

Previous conversational style AI assistance either generate very simple code to prioritize speed or suffer from long generation times. For instance, previous AI assistants in which an AI was used to generate code required that the user provide a detailed prompt and wait for a significant amount of time for the AI to generate code. Often, the end result or steps of the code were not what the user had hoped that the code would execute, so the user would have to attempt to prompt the AI again and, again, wait for it to generate the code. This process can lead to significant latency and delay between the time the user provides a description, and when the AI assistant can generate a workflow. In addition, there is no opportunity for the user to refine their objectives before committing to the entire workflow being generated. For instance, because there was no confirmation of the code before it is generated, previous codes required significant delay in the back and forth with the user.

Accordingly, earlier solutions led to a slow iteration cycle between AI and a user in building a workflow, such as where a user must wait for the entire workflow to be built before proceeding, for example, due to a lack of transparency between the AI and the user on the final outcome of the generation. Furthermore, generating the entire code repeatedly by the AI assistant results not only in significant delay, it also greatly increases the processing and token usage by the AI.

In other previous implementations, when a user manually builds a workflow or code, previous technologies required that they determine and solve steps of the workflow one by one, for example, where triggers and actions are set up one by one.

Accordingly, previous technologies fail to discern a user's intent and, therefore, required significant back-and-forth while generating, or a user was required to manually generate code or workflows step by step.

### SUMMARY

This disclosure describes technology that addresses the above-noted deficiencies of existing solutions by providing technology for generating and updating workflow outlines, for example, using an artificial intelligence assistant, among other improvements. In some aspects, the techniques described herein relate to a computer-implemented method including: receiving, by one or more processors, one or more user prompts in a conversational interface; determining, by the one or more processors, an intent of a user based on the one or more user prompts using one or more artificial intelligence (“AI”) models; determining, by the one or more processors, to generate a recipe sketch based on the intent of the user, the recipe sketch including one or more triggers and a set of rough automated operations configured to accomplish a task; transmitting, by the one or more processors, a sketch request to the one or more AI models to generate the recipe sketch; receiving, by the one or more processors, the recipe sketch from the one or more AI models; providing, by the one or more processors, a graphical user interface displaying a graphical representation of the recipe sketch to the user; receiving, by the one or more processors, a user input modifying the recipe sketch; transmitting, by the one or more processors, the user input modifying the recipe sketch to the one or more AI models; receiving, by the one or more processors, a modified recipe sketch from the one or more AI models based on the user input modifying the recipe sketch; based on receiving a second user input confirming the modified recipe sketch, transmitting, by the one or more processors, at least a portion of the modified recipe sketch to the one or more AI models with a request to generate a set of executable operations for the modified recipe sketch; and updating, by the one or more processors, the graphical user interface including modifying the graphical representation to indicate the generated set of executable operations.

In some aspects, the techniques described herein relate to a computer-implemented method including: generating, by one or more processors, a recipe sketch based on an intent of a user, the recipe sketch including one or more triggers and a set of rough automated operations configured to accomplish a task; providing, by the one or more processors, a graphical user interface displaying a graphical representation of the recipe sketch to the user; based on a confirmation that the recipe sketch represents the intent of the user, generating, by the one or more processors, a set of executable operations based on the set of rough automated operations of the recipe sketch; and updating, by the one or more processors, the graphical user interface including modifying the graphical representation of the recipe sketch to indicate the generated set of executable operations.

In some aspects, the techniques described herein relate to a computer-implemented method, wherein: the recipe sketch includes an outline of a workflow of the one or more triggers and the set of rough automated operations to perform the task.

In some aspects, the techniques described herein relate to a computer-implemented method, wherein modifying the graphical representation of the recipe sketch to indicate the generated set of executable operations includes: replacing each of a first set of graphical elements with a second set of graphical elements in the graphical user interface iteratively as each of the set of executable operations is generated, the first set of graphical elements representing the set of rough automated operations, the second set of graphical elements representing the generated set of executable operations.

In some aspects, the techniques described herein relate to a computer-implemented method, wherein: the first set of graphical elements representing the set of rough automated operations includes a first level of detail about the set of rough automated operations; and the second set of graphical elements representing the generated set of executable operations include a second level of detail about the set of executable operations, the second level being a greater level of detail than the first level.

In some aspects, the techniques described herein relate to a computer-implemented method, wherein: the set of rough automated operations lack sufficient detail to be performed by the one or more processors; and the generated set of executable operations include sufficient detail to be performed by the one or more processors.

In some aspects, the techniques described herein relate to a computer-implemented method, further including: transmitting, by the one or more processors, a sketch request to one or more artificial intelligence (AI) models to generate the recipe sketch; and receiving, by the one or more processors, the recipe sketch from the one or more AI models.

In some aspects, the techniques described herein relate to a computer-implemented method, further including: receiving, by the one or more processors, a user input modifying the recipe sketch; transmitting, by the one or more processors, the user input modifying the recipe sketch to one or more artificial intelligence (AI) models; and updating, by the one or more processors, the graphical representation of the recipe sketch based on a modification of the recipe sketch by the one or more AI models.

In some aspects, the techniques described herein relate to a computer-implemented method, further including determining the intent of the user to create the recipe sketch including: receiving, by the one or more processors, one or more text prompts from the user in a conversational interface; and inputting, by the one or more processors, the one or more text prompts from the user into one or more artificial intelligence (AI) models.

In some aspects, the techniques described herein relate to a computer-implemented method, further including: receiving, by the one or more processors, a modified recipe sketch from one or more artificial intelligence (AI) models based on a user input modifying the recipe sketch; updating, by the one or more processors, the graphical user interface displaying the graphical representation of the recipe sketch based on the modified recipe sketch; and based on receiving a user input confirming the modified recipe sketch, transmitting, by the one or more processors, at least a portion of the modified recipe sketch to the one or more AI models with a request to generate the set of executable operations for the modified recipe sketch.

In some aspects, the techniques described herein relate to a computer-implemented method, further including: determining the intent of the user based on one or more user prompts using one or more artificial intelligence (AI) models includes: transmitting the one or more user prompts to a first large language model; and receiving a response from the first large language model indicating that the user is requesting to generate a workflow for automating the task.

In some aspects, the techniques described herein relate to a computer-implemented method, further including: transmitting a sketch request to generate the recipe sketch to a second large language model, the sketch request reflecting the one or more user prompts.

In some aspects, the techniques described herein relate to a computer-implemented method, wherein generating the set of executable operations includes: transmitting the recipe sketch to a third large language model, the third large language model determining a logic for each of the set of rough automated operations.

In some aspects, the techniques described herein relate to a system including: one or more processors; and a computer-readable memory storing instructions that, when executed by the one or more processors, cause the system to perform operations including: generating, by the one or more processors, a recipe sketch based on an intent of a user, the recipe sketch including one or more triggers and a set of rough automated operations configured to accomplish a task; providing, by the one or more processors, a graphical user interface displaying a graphical representation of the recipe sketch to the user; based on a confirmation that the recipe sketch represents the intent of the user, generating, by the one or more processors, a set of executable operations based on the set of rough automated operations of the recipe sketch; and updating, by the one or more processors, the graphical user interface including modifying the graphical representation of the recipe sketch to indicate the generated set of executable operations.

In some aspects, the techniques described herein relate to a system, wherein: the recipe sketch includes an outline of a workflow of the one or more triggers and the set of rough automated operations to perform the task.

In some aspects, the techniques described herein relate to a system, wherein modifying the graphical representation of the recipe sketch to indicate the generated set of executable operations includes: replacing each of a first set of graphical elements with a second set of graphical elements in the graphical user interface iteratively as each of the set of executable operations is generated, the first set of graphical elements representing the set of rough automated operations, the second set of graphical elements representing the generated set of executable operations.

In some aspects, the techniques described herein relate to a system, wherein: the first set of graphical elements representing the set of rough automated operations includes a first level of detail about the set of rough automated operations; and the second set of graphical elements representing the generated set of executable operations include a second level of detail about the set of executable operations, the second level being a greater level of detail than the first level.

In some aspects, the techniques described herein relate to a system, wherein: the set of rough automated operations lack sufficient detail to be performed by the one or more processors; and the generated set of executable operations include sufficient detail to be performed by the one or more processors.

In some aspects, the techniques described herein relate to a system, further including: transmitting, by the one or more processors, a sketch request to one or more artificial intelligence (AI) models to generate a sketch; and receiving, by the one or more processors, the recipe sketch from the one or more AI models.

In some aspects, the techniques described herein relate to a system, wherein the operations further include: receiving, by the one or more processors, a user input modifying the recipe sketch; transmitting, by the one or more processors, the user input modifying the recipe sketch to one or more artificial intelligence (AI) models; and updating, by the one or more processors, the graphical representation of the recipe sketch based on a modification of the recipe sketch by the one or more AI models.

Other implementations of one or more of these aspects or other aspects include corresponding systems, apparatus, and computer programs, configured to perform the various actions and/or store various data described in association with these aspects. These and other implementations, such as various data structures, are encoded on tangible computer storage devices. Numerous additional features may, in some cases, be included in these and various other implementations, as discussed throughout this disclosure. It should be understood that the language used in the present disclosure has been principally selected for readability and instructional purposes, and not to limit the scope of the subject matter disclosed herein.

### BRIEF DESCRIPTION OF THE DRAWINGS

The patent or application file contains at least one drawing executed in color. Copies of this patent or patent publication with color drawing(s) will be provided by the Office upon request and payment of the necessary fee.

This disclosure is illustrated by way of example, and not by way of limitation in the figures of the accompanying drawings in which like reference numerals are used to refer to similar elements.

FIG. 1 is a block diagram illustrating an example integration management system encompassed by the technology.

FIG. 2 is a block diagram of an example computing system.

FIGS. 3A and 3B illustrate a flowchart depicting an example method for generating and updating workflow outlines using an artificial intelligence agent.

FIGS. 4A-4E illustrate example graphical user interface(s) for generating and updating workflow outlines using an artificial intelligence agent according to some implementations.

FIGS. 5-29 illustrate example graphical user interface(s) for generating and updating workflow outlines using an artificial intelligence agent according to some implementations.

### DETAILED DESCRIPTION

The innovative technology disclosed in this application is capable of, for instance, improving the generation of automated workflows or code. For instance, the disclosure relates to a system and method for generating and updating workflow outlines using an artificial intelligence (AI) agent.

The technology may include code and interfaces for generating and updating workflows (e.g., low code automations) using an AI assistant. This technology may include using an AI assistant to create an outline or sketch of an overall workflow for accomplishing an automated task. In some cases, the user may communicate with the AI assistant to iteratively adjust the outline. Once the outline of the workflow is established, the AI may then go through the outline step by step to generate code and associated information for the steps. The technology may allow a user to converse with an AI assistant to generate new workflows or update existing workflows through quick iterations on a proposed outline or sketch. This technology may provide an alternative way for users to interface with an AI assistant to build workflows faster while achieving better results.

Among other benefits, the technology allows a rapid iteration cycle between a human and an AI assistant using pseudocode representing a workflow for generating and/or updating workflow. The technology may provide a clear confirmation of the determined intent from an assistant through a sketch before proceeding with a potentially asynchronous, generation process. The technology may also help users update existing workflows by showcasing updates to the workflow as sketch updates.

The technology provides a new way for human users to work with AI assistants to generate and update workflows through the improved outlines, which may also be referred to as sketches herein, and may be represented in an adaptable graphical interface. For instance, a user may converse with the AI assistant and, after sufficient details are provided, the AI assistant will produce a sketch. A sketch can be displayed as pseudocode, flowchart, or other display on a workflow canvas interface for the user to understand clearly how the workflow is going to be generated, for example, without knowing the final details of the workflow, such as mappings of values between systems, details of individual steps, or other details, as noted below. The sketch of the workflow may allow the user to confirm if the AI assistant has understood the user's intent correctly. If not, the user can provide further guidance to the assistant to change the sketch until the user's intent is satisfied. The updated sketch may then be presented to the user again for confirmation.

Some implementations of the technology may achieve the benefits by displaying a new way for workflows to be represented in a canvas based on the response from an AI assistant. These steps may include translating a user intent into the generation of a sketch, translating user intent into the updating of a sketch, and, upon confirmation of the sketch from the user, turning a sketch into a fully functioning workflow, which may occur incrementally (e.g., for each step of the workflow or sketch). Accordingly, users using an AI assistant may be able to get a better workflow generated with less time needed between iterations. For instance, users can visually see and confirm the proposed workflow that the AI assistant will generate before it is fully completed.

Accordingly, the technology may assist users in building better, longer, or more accurate workflows/software recipes/code, for example, due in part to how it splits up the process of generating the workflows. For instance, a first part of the technology may use a large language model (LLM) or other AI that is fine tuned to be able to generate a recipe sketch/outline, so the user can see and confirm that it is performing the steps that they intend before the workflow is actually built. For example, where the inner workings of the code or steps, including mappings between different systems, have not yet been generated. Once the technology receives a user confirmation for one or more steps, the technology may iterate generating code, accessing a knowledge base; communicating with external sources, tools or agents; and/or communicating with the user to build a fully functioning workflow.

Because the technology can confirm user intent through the sketch, initially it may not need to perform API (application programming interface) calls, retrieving metadata from connected applications or services (e.g., other servers, services, programs, etc., used in the workflow), solving the details of the recipe, determining what data maps to the steps, determining dependencies, or other incremental steps that the AI/LLM may have to solve to generate the workflow. Accordingly, because previous systems confirmed intent after generating a completed workflow, this improved technology may save significant time, computing resources, tokens used and provide other technical improvements that allow more complex and accurate code, such as longer, better software recipes or automated workflows.

These and other benefits, operations, and features are described by way of example in the implementations herein. It should be noted that while certain examples are provided, these are not exhaustive, and others are possible and contemplated herein.

With reference to the figures, reference numbers may be used to refer to components found in any of the figures, regardless of whether those reference numbers are shown in the figures being described. Further, where a reference number includes a letter referring to one of multiple similar components (e.g., component 000a, 000b, and 000n), the reference number may be used without the letter to refer to one or all of the similar components.

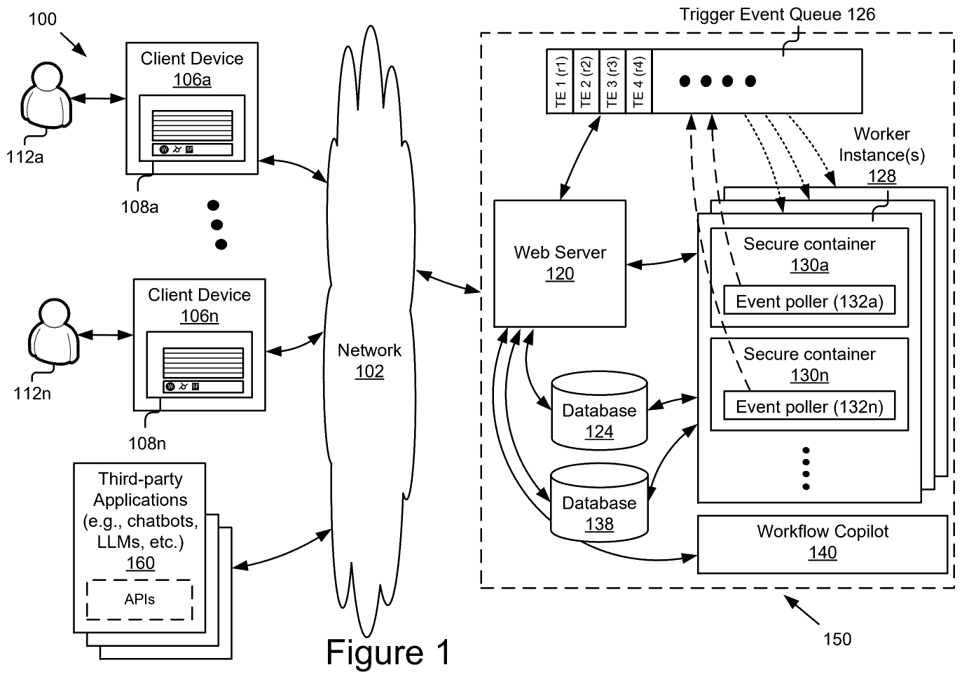

FIG. 1 is a block diagram illustrating an example system 100 in which the technology may be used. The illustrated example system 100 includes client devices 106a . . . 106n, a server system 150, and third-party applications 160, which are communicatively coupled via a network 102 for interaction with one another. For example, the client devices 106a . . . 106n may be respectively coupled to the network 102 and may be accessible by users 112a . . . 112n (also referred to individually and collectively as 112). The server system 150 and third-party applications 160 may be communicatively coupled to the network 102. The use of the nomenclature “a” and “n” in the reference numbers indicates that any number of those elements having that nomenclature may be included in the system 100. The architecture, location of services, and other features are described by way of example.

The network 102 may include any number of networks and/or network types. For example, the network 102 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, peer-to-peer networks, other interconnected data paths across which multiple devices may communicate, various combinations thereof, etc. Data transmitted by the network 102 may include packetized data (e.g., Internet Protocol (IP) data packets) that is routed to designated computing devices coupled to the network 102. In some implementations, the network 102 may include a combination of wired and wireless networking software and/or hardware that interconnects the computing devices of the system 100. For example, the network 102 may include packet-switching devices that route the data packets to the various computing devices based on information included in a header of the data packets.

The client devices 106a . . . 106n (also referred to individually and collectively as 106) include computing systems having data processing and communication capabilities. In some implementations, a client device 106 may include a processor (e.g., virtual, physical, etc.), a memory, a power source, a network interface, and/or other software and/or hardware components, such as a display, graphics processor, wireless transceivers, keyboard, camera, sensors, firmware, operating systems, drivers, and/or various physical connection interfaces (e.g., USB, HDMI, etc.), etc. The client devices 106a . . . 106n may couple to and communicate with one another and the other entities of the system 100 via the network 102 using a wireless and/or wired connection.

Examples of client devices 106 may include, but are not limited to, mobile phones (e.g., feature phones, smart phones, etc.), tablets, laptops, desktops, netbooks, server appliances, servers, virtual machines, TVs, set-top boxes, media streaming devices, portable media players, navigation devices, personal digital assistants, etc. While two or more client devices 106 are depicted in FIG. 1, the system 100 may include any number of client devices 106. In addition, the client devices 106a . . . 106n may be the same or different types of computing systems.

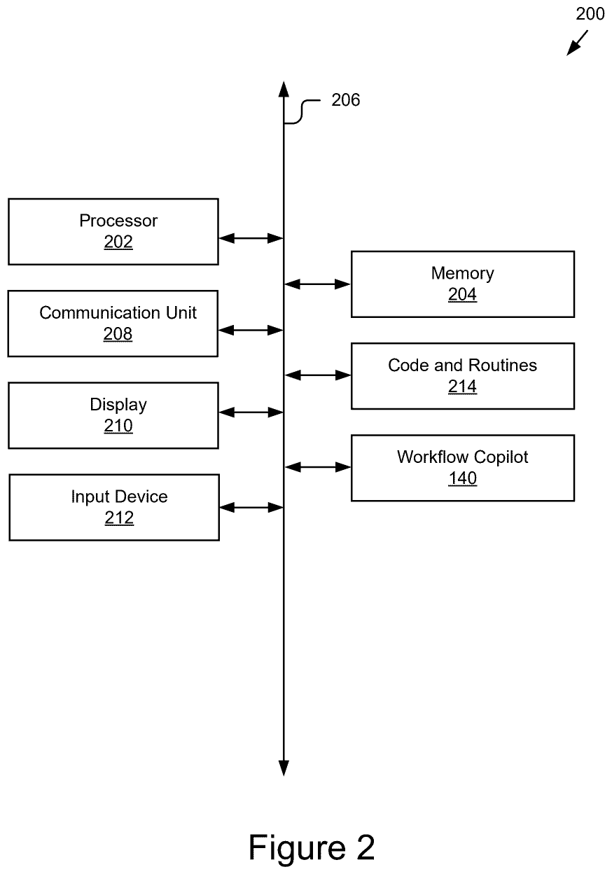

In the depicted implementation, the client devices 106a . . . 106n respectively contain instances 108a . . . 108n of a client application (also referred to individually and collectively as 108). The client application 108 may be storable in a memory (e.g., see FIG. 2) and executable by a processor (e.g., see FIG. 2) of a client device 106 to provide for user interaction, receive user input, present information to the user via a display (e.g., see FIG. 2), and send data to and receive data from the other entities of the system 100 via the network 102. Examples of various interfaces that can be rendered and presented by the client application 108 are depicted herein. In some implementations, the client application 108 may present or interact with a chat application or conversational interface operable on a third-party server (not shown) and/or on the server system 150.

In some implementations, the client application 108 may generate and present various user interfaces to perform these acts and/or functionality, such as the example graphical user interfaces discussed elsewhere herein, which may, in some cases, be based at least in part on information received from local storage, the server system 150, and/or one or more of the third-party applications 160 via the network 102. In some implementations, the client application 108 is code operable in a web browser, a native application (e.g., mobile app), a combination of both, etc. Additional structure, acts, and/or functionality of the client devices 106 and the client application 108 are described in further detail elsewhere in this document.

In some implementations, the client application 108 may include or communicate with the workflow copilot 140, as described in further detail below. For instance, the client application 108 may incorporate some or all of the functionality described in reference to the workflow copilot 140.

The server system 150, a third-party server (not shown), and/or the third-party applications 160 may include one or more computing systems having data processing, storing, and communication capabilities. For example, these entities 150 and/or 160 may include one or more hardware servers, virtual servers, server arrays, storage devices and/or systems, etc., and/or may be centralized or distributed/cloud based. In some implementations, these entities 150 and/or 160 may include one or more virtual servers, which operate in a host server environment and access the physical hardware of the host server including, for example, a processor, memory, storage, network interfaces, etc., via an abstraction layer (e.g., a virtual machine manager).

In the depicted implementation, the server system 150 includes a web server 120, a trigger event queue 126, databases 124 and 138, worker instances 128, and a workflow copilot 140. These components, and their sub-components, are coupled for electronic communication with one another, and/or the other elements of the system 100. In some instances, these components may communicate via direct electronic connections or via a public and/or private computer network, such as the network 102.

In some implementations, a worker instance 128 represents a worker compute node and may include more than one secure container 130a . . . 130n, as shown in FIG. 1. A container in the worker instance 128, at a given time, may run a recipe. A container may add trigger events to the trigger event queue 126 and (responsive to the trigger event being triggered) receive events from the trigger event queue 126. The event poller 132 (instances 132a . . . 132n are illustrated) is software configured to poll for messages indicating the completion of a prior call so the secure container can proceed to the next step of the recipe (or to completion as the case may be). The server system 150 may utilize any suitable runtime environment and process queue/worker architecture, such as Heroku™M.

The web server 120 includes computer logic executable by the processor 202 (see FIG. 2) to process content requests. The web server 120 may include an HTTP server, a REST (representational state transfer) service, or other suitable server type. The web server 120 may receive content requests (e.g., product search requests, HTTP requests, commands, etc.) from client devices 106, cooperate with the other components of the server system 150 (e.g., workflow copilot 140, worker instances 128, trigger event queue 126, etc.) to determine the content and/or trigger processing, retrieve and incorporate data from the databases 124 and 138, format the content, and provide the content to the client devices 106. In some instances, the web server 120 may format the content using a web language and provide the content to a corresponding client application 108 for processing and/or rendering to the user for display. The web server 120 may be coupled to the databases 124 and 138 to store retrieve, and/or manipulate data stored therein.

In some implementations, the components 108, 120, 128, 126, and/or 140 may include computer logic storable in the memory 204 and executable by the processor 202, and/or implemented in hardware (e.g., ASIC, FPGA, ASSP, SoC, etc.), in some implementations, the client application 108, the web server 120, the worker instances 128, the trigger event queue 126, and/or the workflow copilot 140, and/or their sub-modules are sets of instructions executable by the processor 202 to provide their functionality. In some implementations, these components and/or their sub-components are stored in the memory 204 of the computing system 200 and are accessible and executable by the processor 202 to provide their functionality. In any of the foregoing implementations, these components and/or their sub-components may be adapted for cooperation and communication with the processor 202 and other components of the computing system 200.

The databases 124 and 138 are information sources for storing and providing access to data. Examples of the types of data stored by the databases 124 and 138 may include user and partner account information, codes representing the recipes, requirement tables associated with the codes, input and output schemas associated with the codes and/or applications, event data, metadata, objects associated with the applications, codes, and/or schemas, etc., and/or any of the other data discussed herein that is received, processed, stored, or provided by the integration management system 100. Recipes may be associated with a user's account.

The databases 124 and 138 may be included in the computing system 200 or in another computing system and/or storage system distinct from but coupled to or accessible by the computing system 200. The databases 124 and 138 can include one or more non-transitory computer-readable mediums for storing the data. In some implementations, the databases 124 and 138 may be incorporated with the memory 204 or may be distinct therefrom. In some implementations, the databases 124 and 138 may include a database management system (DBMS) operable on the computing system 200. For example, the DBMS could include a structured query language (SQL) DBMS, a NoSQL DBMS, various combinations thereof, etc. In some instances, the DBMS may store data in multi-dimensional tables comprised of rows and columns, and manipulate, i.e., insert, query, update and/or delete, rows of data using programmatic operations.

The third-party applications 160a . . . 160n, as depicted, may respectively expose APIs 162 for accessing the functionality and data of the third-party applications 160a . . . 160n (also referred to individually and collectively as 160). An application 160 may include hardware (e.g., a server) configured to execute software, logic, and/or routines to provide various services (consumer, business, etc.), such as video, music and multimedia hosting, distribution, and sharing; email; social networking; blogging; micro-blogging; photo management; cloud-based data storage and sharing; ERM; CRM; financial services; surveys; marketing; analytics; a combination of one or more of the foregoing services; or any other service where users store, retrieve, collaborate, generate, consume, and/or share information.

In some implementations, the third-party applications 160 may include messaging services, artificial intelligence models, chat bots, or other services. For example, in some implementations, the third-party application 160 may include one or more artificial intelligence agents or large language models that receive textual or other inputs and, based on training, determine intent, generate outputs, etc. For instance, some large language models may include Llama™, Gemini™, ChatGPT™, Claude™, etc., that may be hosted on a first-party or third-party server. These or other models may be tuned using user or company specific data, such as previous code, workflows, recipes, etc., generated in a training and/or verification dataset.

In some implementations, the client application 108, the various components of the server system 150, the third-party applications 160, etc., may require users 112 to be registered to access the acts and/or functionality provided by them. For example, to access various acts and/or functionality provided by these components, the components may require a user 112 to authenticate his/her identity (e.g., by confirming a valid electronic address or other information). In some instances, these entities 108, 120, 140, 160, etc., may interact with a federated identity server (not shown) to register/authenticate users 112. Once registered, these entities may require a user 112 seeking access to authenticate by inputting credentials in an associated user interface.

The system 100 illustrated in FIG. 1 may be representative of an example system for collaborative design, and it should be understood that a variety of different system environments and configurations are contemplated and are within the scope of the present disclosure. For instance, various functionality may be moved from a server to a client, or vice versa and some implementations may include additional or fewer computing systems, services, and/or networks, and may implement various functionality client or server-side. Further, various entities of the system 100 may be integrated into a single computing device or system or additional computing devices or systems, etc.

Additional acts, structure, and/or functionality of at least the client devices 106, the server system 150, the third-party applications 160, and their constituent components are described in further detail below.

FIG. 2 is a block diagram of an example computing system 200. The example computing system 200 may represent the computer architecture of a client device 106, a server system 150, a server of a conversational interface application, a server or computing device of a workflow copilot 140, and/or a server of the third-party application 160, depending on the implementation. As depicted, the computing system 200 may include a processor 202, a memory 204, a communication unit 208, a display 210, and an input device 212, which may be communicatively coupled by a communications bus 206. The computing system 200 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc.

The processor 202 may execute software instructions by performing various input/output, logical, and/or mathematical operations. The processor 202 may have various computing architectures to process data signals including, for example, a complex instruction set computer (CISC) architecture, a reduced instruction set computer (RISC) architecture, and/or an architecture implementing a combination of instruction sets. The processor 202 may be physical and/or virtual and may include a single core or plurality of processing units and/or cores. In some implementations, the processor 202 may be capable of generating and providing electronic display signals to a display device, supporting the display of images, capturing and transmitting images, performing complex tasks including various types of feature extraction and sampling, etc. In some implementations, the processor 202 may be coupled to the memory 204 via the bus 206 to access data and instructions therefrom and store data therein. The bus 206 may couple the processor 202 to the other components of the computing system 200 including, for example, the memory 204, the communication unit 208, display 210, and the input device 212.

The memory 204 may store and provide access to data to the other components of the computing system 200. The memory 204 may be included in a single computing device or a plurality of computing devices as discussed elsewhere herein. In some implementations, the memory 204 may store instructions and/or data that may be executed by the processor 202. For example, the memory 204 may include various different combinations of the software components described herein, depending on the configuration. The memory 204 is also capable of storing other instructions and data, including, for example, an operating system, hardware drivers, other software applications, databases, etc. The memory 204 may be coupled to the bus 206 for communication with the processor 202 and the various other components of computing system 200.

The memory 204 includes a non-transitory computer-usable (e.g., readable, writeable, etc.) medium, which can be any tangible apparatus or device that can contain, store, communicate, propagate or transport instructions, data, computer programs, software, code, routines, etc., for processing by or in connection with the processor 202. In some implementations, the memory 204 may include one or more of volatile memory and non-volatile memory. For example, the memory 204 may include, but is not limited, to one or more of a dynamic random access memory (DRAM) device, a static random access memory (SRAM) device, a discrete memory device (e.g., a PROM, FPROM, ROM), a hard disk drive, an optical disk drive (CD, DVD, Blue-ray™, etc.). It should be understood that the memory 204 may be a single device or may include multiple types of devices and configurations.

The bus 206 can include a communication bus for transferring data between components of a computing system or between computing systems, a network bus system including the network 102 and/or portions thereof, a processor mesh, a combination thereof, etc. In some implementations, the various components of the system 100 may cooperate and communicate via a software communication mechanism implemented in association with the bus 206. The software communication mechanism can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 208 may include one or more interface devices (I/F) for wired and/or wireless connectivity with the network 102 and/or other computing systems. For instance, the communication unit 208 may include, but is not limited to, CAT-type interfaces; wireless transceivers for sending and receiving signals using Wi-FiTM, Bluetooth®, IrDA™, Z-Wave™, ZigBee®, cellular communications, and the like, etc.; USB interfaces; various combinations thereof; etc. The communication unit 208 may connect to and send/receive data via a mobile network, a public IP network of the network 102, a private IP network of the network 102etc.In some implementations, the communication unit 208 can link the processor 202 to the network 102, which may in turn be coupled to other processing systems. The communication unit 208 can provide other connections to the network 102 and to other entities of the system 100 using various standard network communication protocols, including, for example, those discussed elsewhere herein.

The display 210 may display electronic images and data output by the computing system 200 for presentation to a user 112. The display 210 may include any conventional display device, monitor or screen, including, for example, an organic light-emitting diode (OLED) display, a liquid crystal display (LCD), etc. In some implementations, the display 210 may be a touchscreen display capable of receiving input from one or more fingers of a user 112. For example, the display 210 may be a capacitive touchscreen display capable of detecting and interpreting multiple points of contact with the display surface. In some implementations, the computing system 200 may include a graphics adapter (not shown) for rendering and outputting the images and data for presentation on display 210. The graphics adapter (not shown) may be a separate processing device including a separate processor and memory (not shown) or may be integrated with the processor 202 and memory 204.

The input device 212 may include any device for inputting information into the computing system 200. In some implementations, the input device 212 may include one or more peripheral devices. For example, the input device 212 may include a keyboard (e.g., a QWERTY keyboard), a pointing device (e.g., a mouse or touchpad), microphone, an image/video capture device (e.g., camera), etc. In some implementations, the input device 212 may include a touchscreen display capable of receiving input from the one or more fingers of the user. For instance, the structure and/or functionality of the input device 212 and the display 210 may be integrated, and a user of the computing system 200 may interact with the computing system 200 by contacting a surface of the display 210 using one or more fingers. In this example, the user could interact with an emulated (i.e., virtual or soft) keyboard displayed on the touchscreen display 210 by using fingers to contact the display in the keyboard regions.

A recipe may be an integration flow that contains a trigger and a set of actions. The trigger causes the actions in a recipe to be executed. Actions are the routines the recipe runs. Each action may include an input configuration and is associated with a given application (e.g., a third-party application 160). Each trigger and action may further include metadata, such as an input schema and an output schema. Actions may run in parallel, series, or various combinations thereof. In some instances, one action may be dependent upon the output of a preceding action. In a typical recipe configuration, the different actions in the recipe are associated with different applications, and the recipe automates the interaction between the different applications using the application programming interfaces (APIs) of those applications. For instance, the recipe may flow, sync, etc., data from one application to another, populate multiple different applications with data from a certain source application, etc. In some implementations, the recipes are written in Ruby, and the secure containers 130 of the worker instances 128 interpret and process the recipes, although it should be understood that other languages and interpreters may be used. A workflow may include one or more recipes, for example.

In some implementations, one or more modules or engines, such as a workflow copilot 140, code and routines 214, or components may be included and may include computer logic storable in the memory 204 and executable by the processor 202, and/or implemented in hardware to provide its acts and/or functionality, such as the description herein. Other code and routines 214 may be used to provide other communication and functionality of the computing device 200. For instance, a workflow copilot 140 may be machine learning or large language model or a decision or logic based application that may provide or interact with a user via a chat or other user interface, for example, where a user may ask an AI assistant to do something within a platform.

In some implementations, a workflow copilot 140 may include or may interface with an AI assistant. For instance, a workflow copilot 140 may alternatively be referred to herein as an AI assistant, and/or it may interface with one or more AI assistants, or large language models, etc.

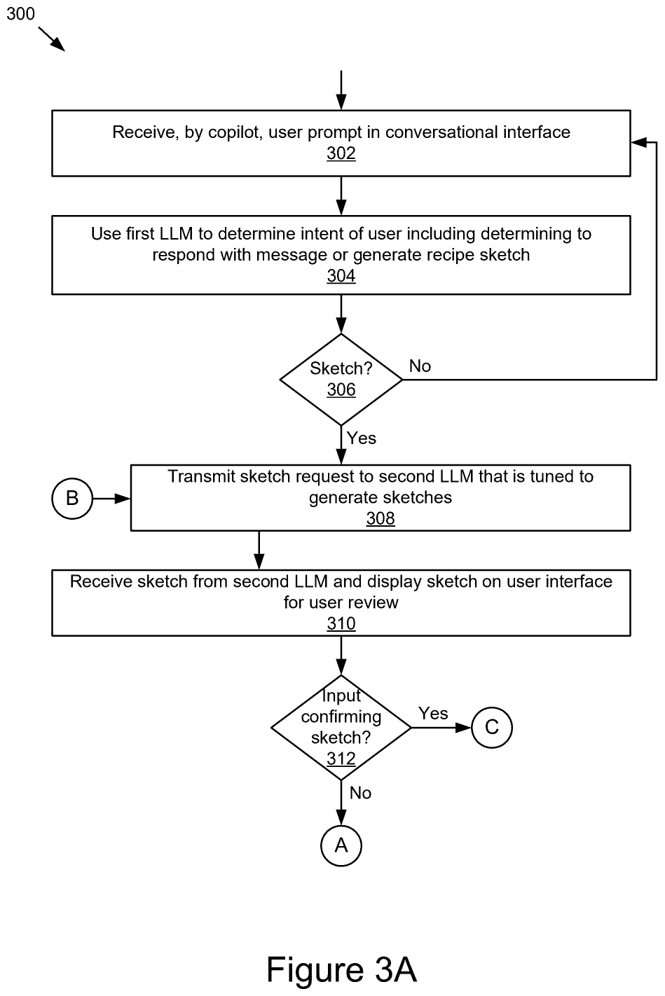

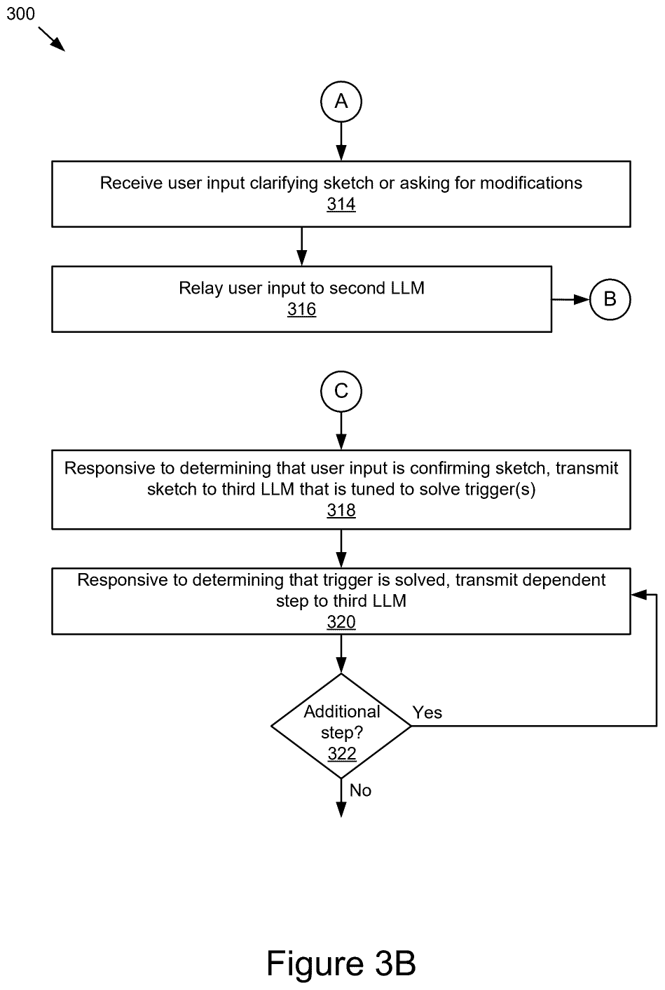

FIGS. 3A and 3B illustrate a flowchart depicting an example method 300 for generating and updating workflow outlines using an artificial intelligence agent, and generating, at once or iteratively, a workflow based on the workflow outlines. For instance, the method 300 may generate an intelligent workflow or other code through an iterative process, as noted in further detail above and elsewhere herein. For example, because the method provides a sketch or outline of a workflow prior to fully generating the workflow in order to better understand the user's intent and, because the full workflow may not be generated until after the user has approved the outline, tokens, processor cycles, bandwidth, and time may be saved, among other benefits.

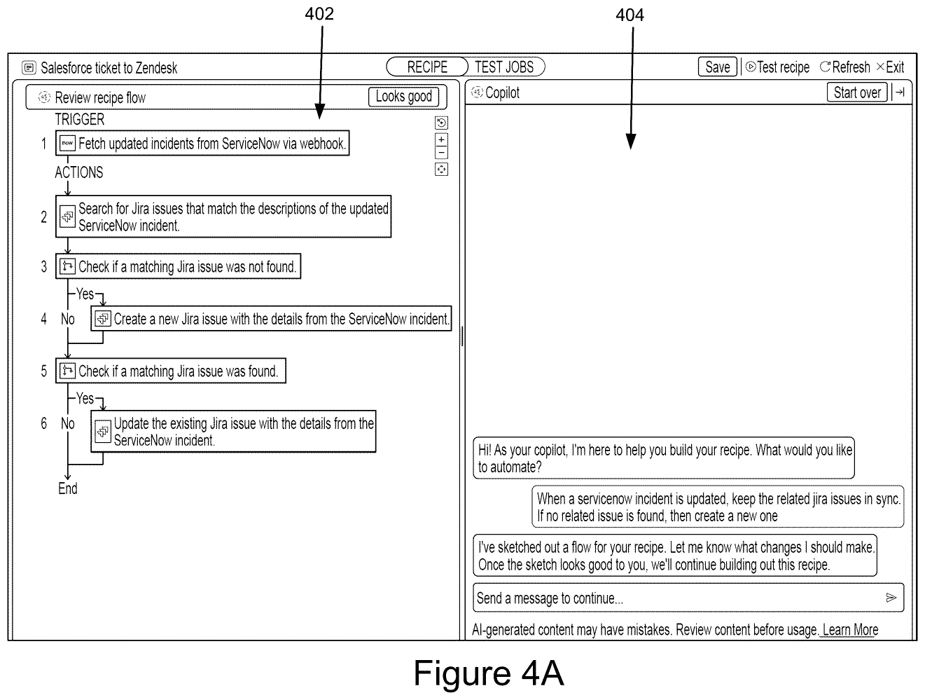

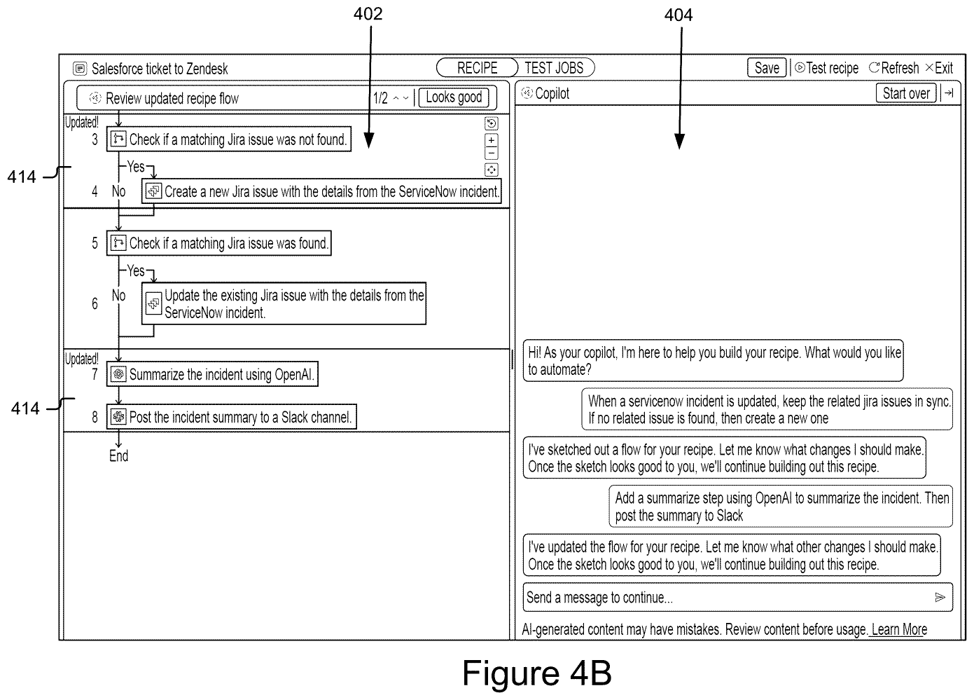

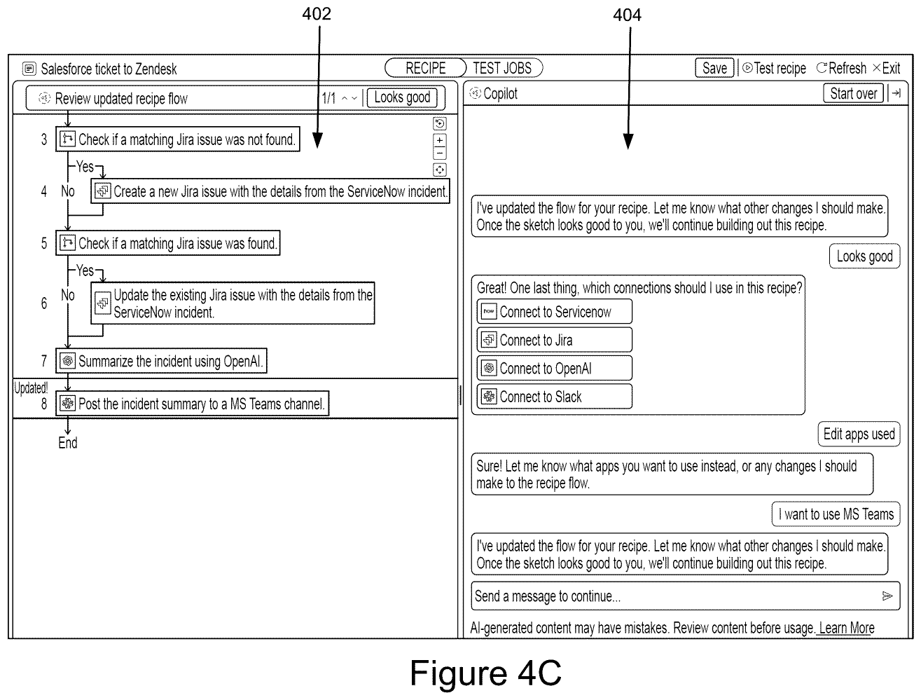

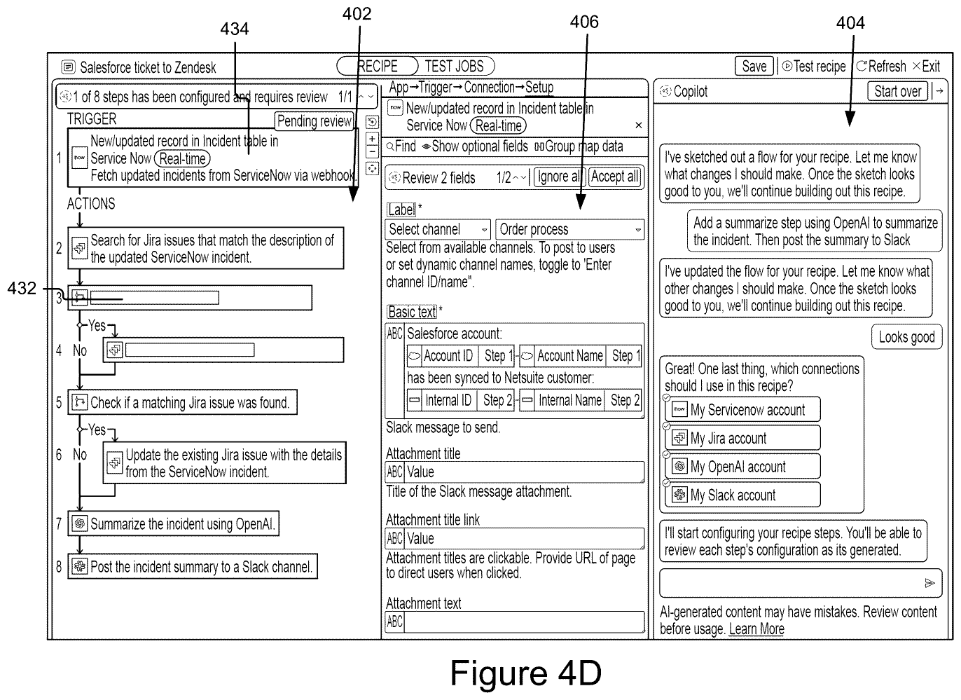

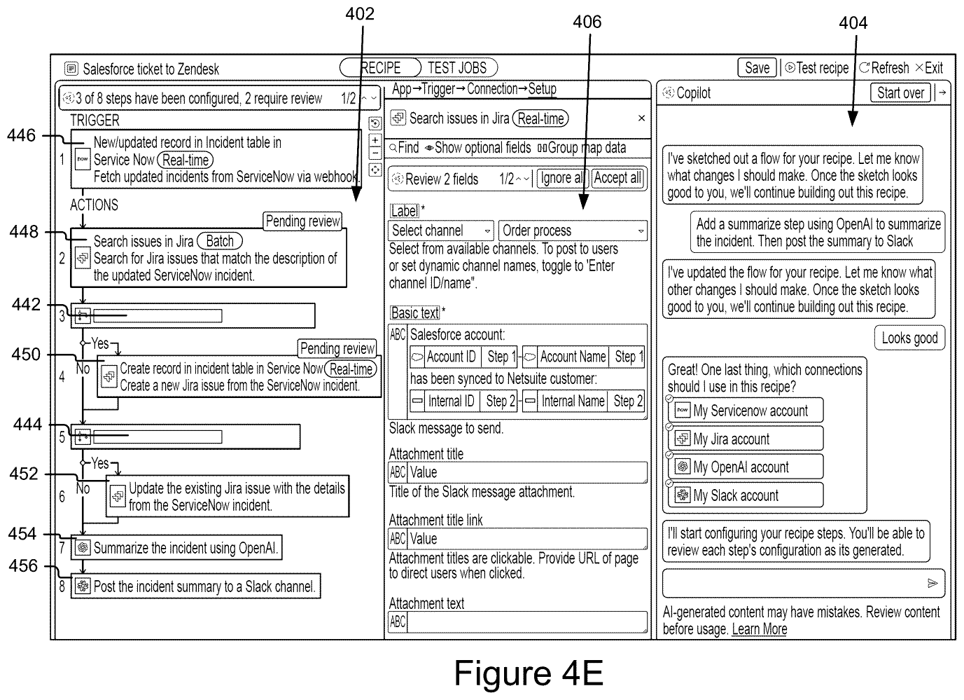

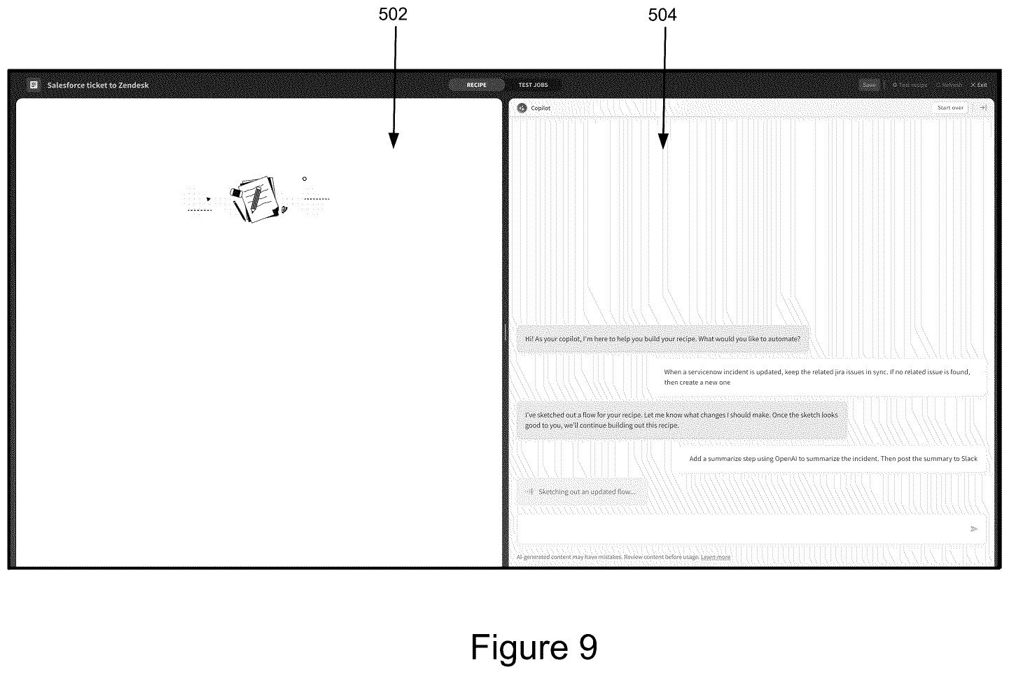

In some implementations, at 302, the workflow copilot 140 may receive one or more user prompts in a conversational interface. Example user interfaces are provided in FIGS. 4A-29. For instance, the workflow copilot 140 may transmit the one or more user prompts received in a chat to a first LLM, or the workflow copilot 140 may represent a first LLM, which may interface with one or more other AI assistants or LLMs. While an LLM is provided as an example herein, other AI models, such as diffusion models, neural networks, or other machine learning models may additionally or alternatively be used.

In some implementations, at 304, the workflow copilot 140 may use a first LLM to determine the user's intent, including whether to respond with a message or generate a recipe sketch, for example, based on a response to the one or more prompts.

In some instances, a chat interface allows a user to interface and confirm intent as noted below, for example, because typically an LLM does not know whether it has properly understood the user's intent. In some cases, the workflow copilot 140 may use a first LLM to determine an intent of the user including determining to respond with a message or generate a recipe sketch. As noted above, a sketch may include an outline, pseudocode, or flowchart of one or more automated operations to perform one or more tasks.

For example, the workflow copilot 140 may provide a way for human users to work with AI assistants to generate and update workflows through outlines-also referred to as “sketches”. The user can converse with the AI assistant and, after sufficient details are provided, the AI assistant will produce a sketch. In some implementations, the sketch can be displayed as pseudocode on a workflow canvas (e.g., a graphical panel of the user interface) for the user to understand clearly how the workflow is going to be generated, without knowing the final details of the workflow, such as mappings of values between systems.

The sketch of the workflow may allow the user to confirm if the AI assistant has understood the user's intent correctly. As noted below, if not, the user can provide further guidance to the assistant to change the sketch until the user's intent is satisfied. The updated sketch will then be presented to the user again and/or updated in the graphical user interface for confirmation.

In some implementations, at 306, the workflow copilot 140 may determine whether the user's intent is to generate a sketch. For example, the workflow copilot 140 may determine to generate a recipe sketch based on the intent of the user. The workflow copilot 140 may determine the intent based the AI's output or processing and/or other semantic language processing.

In some implementations, at 308, the workflow copilot 140 may transmit one or more sketch requests to a second LLM that is tuned to generate sketches. For example, the workflow copilot 140 may transmit a sketch request to the one or more AI models to generate a sketch. The sketch request may reflect (e.g., replicate or augment/reword based on input from logic or the first LLM) the one or more prompts. In some implementations, although multiple models are described herein, the same AI model may be configured to perform multiple operations instead of splitting them up among multiple models, for example, where a system prompt, system instructions, role instruction, tool or function instruction, model parameters, response format, or other parameter changes are made to the request, which cause the same model to determine intent; generate a sketch, update a sketch, or generate full recipe, workflow, or code based on the steps; or perform other operations.

For example, if the intent to generate a sketch is determined by the first LLM, the workflow copilot 140 may then send the sketch request to another LLM that is fine-tuned to generate sketches. This second LLM may have been fine-tuned on thousands of previously created recipes to be able to take this user intent and transform it into a sketch, although other implementations, such as a detailed prompt, access to a knowledge base containing instructions, a particular response format definition, or other aspects may be used to cause the generation.

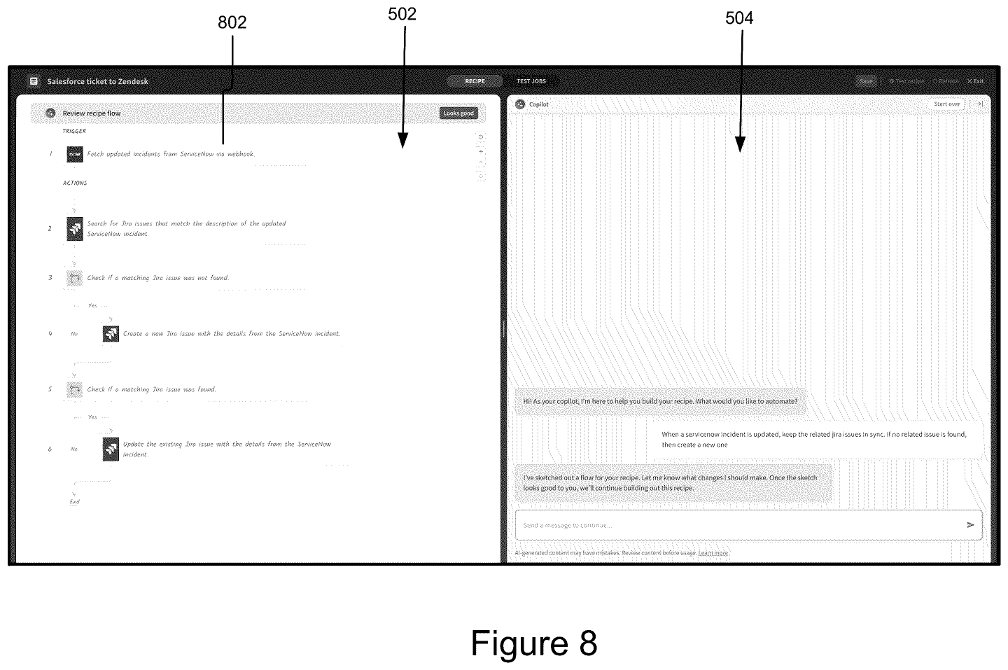

In some implementations, at 310, the workflow copilot 140 may receive a sketch from the second LLM and display the sketch on user interface for user review. For example, the workflow copilot 140 may display the sketch on an adjacent panel (e.g., to a chat interface) of graphical user interface to the user (e.g., as illustrated in the example of FIG. 8).

For example, the sketch of the workflow may allow the user to confirm if the AI assistant has understood the user's intent correctly. If not, after these operations (e.g., at 314-316), the workflow copilot 140 may receive further guidance from the user to change the sketch until the user's intent is satisfied. The updated sketch will then be presented to the user again for confirmation. This process may be repeated until the sketch is deemed satisfactory by the user.

For example, the workflow copilot 140 may display a graphical representation of a recipe or sketch on a user interface (e.g., adjacent to a chat or otherwise) and then ask the user on the chat if it accurately reflects the user's intent. The user can converse with the workflow copilot 140 (e.g., the second LLM or via the second LLM) to update to sketch using the knowledge of the sketch that it already created combined with the user's feedback.

For example, in some implementations, at 312, the workflow copilot 140 may determine whether a user input has been received confirming the sketch. For example, the user may select a graphical element adjacent to the sketch confirming it or may provide a conversational (e.g., textual) confirmation to the workflow copilot 140, which determines directly or based on an LLM that the conversational input includes a confirmation. If input is received confirming the sketch, the method may proceed to 318. If no input is received confirming the sketch or if input is received modifying the sketch, for example, the method may proceed to 314.

In some implementations, at 314, the workflow copilot 140 may receive a user input clarifying the sketch or asking for modifications to the sketch and, at 316, the workflow copilot 140 may relay user input to second LLM. For example, the user's response may be sent to the second LLM directly in the chat (e.g., the chat may, after the sketch is generated, be received by the second LLM) or the workflow copilot 140 (if separate from the second LLM) may relay the user input to the AI assistant (e.g., the second LLM).

For example, the workflow copilot 140 may transmit the user input modifying the sketch to the one or more AI models, and it may receive a modified recipe sketch from the one or more AI models (e.g., the second LLM) based on the user input modifying the sketch. For instance, the method may return to 308 or another step to display the sketch and allow user confirmation or further modification.

In some implementations, at 318, the workflow copilot 140 may, responsive to determining that user input is confirming the sketch, transmit the sketch to one or more AI assistants, such as a third LLM (though using fewer or a single AI model may be used, as noted above) that is tuned to solve steps of the sketch, such as by solving one or more trigger(s) and/or outputs of each step. For example, the third large language model may be fine-tuned to solve datapill mapping. A datapill may be or include output data from a trigger or an action step and including a variable mapping logic into a recipe step. The datapill mapping may include mapping one or more datapills to a field of the one or more triggers or the one or more actions.

For example, if user confirms the recipe, the workflow copilot 140 may begin iteratively turning the sketch into a recipe or other code or workflow. This process may be done by sending the sketch to an LLM that is fine tuned for datapill mapping solving. This LLM may view, analyze, or otherwise review the recipe sketch, determine that it should solve the trigger first, then uses the sketch to understand how to solve how the trigger should be configured, such as in context of the previous step, the next step, or the entire workflow or goal thereof. For example, the workflow copilot 140 may, after confirmation, then begin building the sketch into a full-fledged workflow.

Depending on the workflow, end goal of the workflow, or other factors, the workflow copilot 140 and/or third LLM may iteratively solve (e.g., generate a completed low-code step; select or customize a module, agent, or tool; generate code, etc.); each step of the sketch and, in response, update the graphical interface showing the sketch to show the solved step. For instance, it may change the interface to show that the step is solved, allow the user to view more details of the solved step, or allow the user to manually change it. In other implementations, the workflow copilot 140 may solve the entire sketch all at once and then provided the solved workflow and/or update the interface.

In some implementations, at 320, the workflow copilot 140 may, responsive to determining that trigger is solved, transmit dependent step to the one or more AI assistants, such as the third LLM. For example, the workflow copilot 140 may request that the one or more AI models determine operations for one or more dependencies, dependent steps, or other steps. For example, after the trigger is solved, the steps dependent on the trigger may begin the same process until the recipe is generated.

In some implementations, the workflow copilot 140 may, as one or more of the operations are being solved (e.g., by the third LLM), request and/or receive user input. For instance, the workflow copilot 140 may determine connections to third-party services or applications using user credentials for one or more steps. Similarly, the workflow copilot 140 may request specific details for one or more of the operations.

In some implementations, at 322, the workflow copilot 140 may determine whether the sketch has one or more additional steps to be solved or otherwise configured. If so, the method may continue to the next step, for example, that may depend on a previous step, although other implementations are possible.

In some implementations, the workflow copilot 140 may provide an updated graphical user interface to the user indicating the recipe and/or the workflow, for example, the interface may display the one or more triggers and the one or more dependent steps. In some instances, the graphical user interface may update graphical indications of the steps in the sketch with finalized or generated steps of a workflow, which may include more solved details. In some instances, as described and illustrated in reference to the example user interfaces in FIGS. 4A-29, the sketch may appear as though it's drawn by pencil or otherwise be rough or have other visual appearance indicating that it's a sketch, as noted in the examples herein. Similarly, once the entirety or parts of the sketch are completed as a workflow, the user interface(s) may be updated to solidify the lines, clarify the interface, display the completed or full operations, or otherwise indicate that the step has been computed (e.g., by the third LLM), as noted in the examples herein. In some implementations, the sketch steps may be static or unclickable while the workflow steps may be selectable to view or configure their parameters, etc. In other implementations, the sketch steps may be selectable to allow the user to more-directly provide modifications.

It should be noted that although a linear-solving process is illustrated and described, steps may be solved in different orders or revised during the solving process of another step. In some implementations, a first step in the sketch may be solved followed by a subsequent step and on until the end of the sketch, for example, where each step uses expected inputs of future steps or otherwise. In some implementations, the most complex or restrictive step may be solved first followed by less restrictive or less complex steps. In some implementations, a last step may be solved first and then the process may work backwards in consideration of the input(s) needed for the later steps, for example. In some implementations, one or multiple AI assistants may be used to solve multiple steps simultaneously. In some cases, after a certain step is solved and the workflow copilot 140 determines that a different operation or different data (e.g., a different input) is needed for a later-solved step, the workflow copilot 140 may return and revise the prior-solved step. Accordingly, while a particular example is shown, in other implementations or circumstances, the order or process may be varied.

FIGS. 4A-29 illustrate example graphical user interfaces for allowing a workflow copilot 140/AI assistant 140 to interact with a user to generate, view, modify, and/or confirm a sketch. Similarly, the interface(s) may display sketches, workflows, or combinations thereof. For example, the example interfaces illustrate a generated workflow using and/or otherwise interfaces with third-party services/connections (e.g., with ServiceNow™, Jira™, OpenAI™, and Slack™).

As noted elsewhere herein, the example interfaces may translate user intent into the generation of a sketch, which may allow the AI assistant to return a sketch of the workflow to the user for confirmation based on their intent. The example interfaces may allow the workflow copilot 140 to translate user intent into updating a sketch, so that the user can ask the AI assistant to update the sketch and so that the workflow that will be built is more aligned with the user's expectations. Upon confirmation of the sketch from the user, the workflow copilot 140 may incrementally turn a sketch into a fully functioning workflow and may allow the user to incrementally review what the AI assistant is building, for instance, rather than having to wait until the entire workflow is done before showcasing the entire recipe or providing feedback.

For example, the flow through operations can be seen in the example interfaces for when a user is building a workflow that uses data through multiple services. It should be noted that while the interfaces illustrated in FIGS. 4A-29 are generally in the order through which operations may be performed and in which they may be displayed, some interfaces may be displayed in different orders or based on different inputs, or they may represent alternative implementations.

The graphical user interface(s) may include a recipe editor view, for instance, where there is a canvas or graphical panel on the left of the display, which shows the sketch(es), workflow(s), or other details. This sketch canvas may allow the user to review the sketch as or after it is generated by the AI assistant. For instance, the canvas allows the user to confirm that operations are being performed in a certain way and performing certain actions. For example, a triggering event may be a new opportunity in Salesforce™, and then the app events may be sent to a certain email address. The user may build the sketch on the left side, for instance, via conversational communications in a chat on the right side of the interface. A conversational interface may also provide other AI assistant interactions and guidance in addition to generating sketches and workflows.

It should be noted that the interfaces in FIGS. 4A-29 are described in reference to the workflow copilot 140, but it may apply to various AI assistants, one or more AI models (e.g., LLMs), or other code or modules, as noted elsewhere herein.

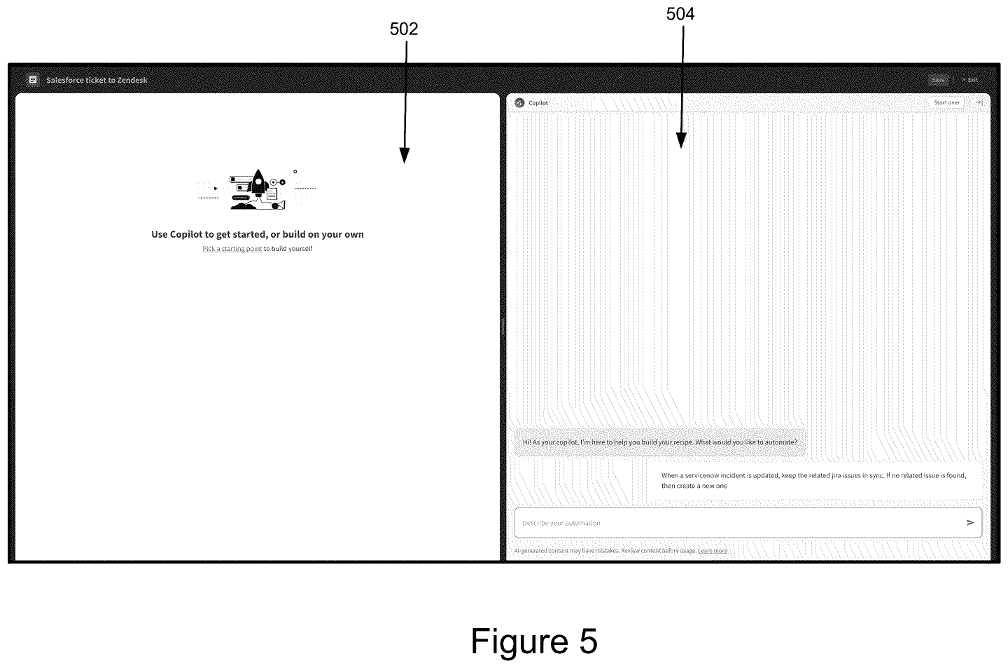

FIGS. 4A-4E illustrate various graphical user interfaces that show a process of a user stepping through a sketch and workflow generation process. Other implementations are possible and contemplated. Additional, similar, or alternative interfaces are further shown and described in reference to FIGS. 5-29.

FIG. 4A illustrates an example graphical user interface in which multiple panels may be displayed. One, two, three, or another quantity of panels may be shown, resized, and rearranged to allow display, configuration, and chat interaction for a workflow.

As shown in FIG. 4A, a workflow panel 402 is shown to the left of a chat panel 404. The workflow panel 402 may be configured to show a flowchart including steps, connectors, and other graphics are shown. The workflow copilot 140 may display elements of a sketch and may update them to show that a workflow has been generated, configured, and/or reviewed. Accordingly, the workflow panel 402 provides dynamic elements with appearances that vary based on the point along the generation process.

As shown in the example, the workflow panel 402 is shown with a series of steps in a sketch format, which may display the steps, boxes, background, connections, or other elements in a basic, grayscale, or otherwise distinguished format. Additionally, the icons and/or text of the steps may display relatively abstract text to indicate its operation without necessarily displaying the specifics of associated programs, schemas, configurations, etc.

As shown in FIG. 4A, a chat panel 404 may allow interaction with a workflow copilot 140, for example, in an iterative chat interface while the workflow copilot 140 uses the chats to determine user intent, seek additional information, and provide information to the user.

FIG. 4B illustrates an example graphical user interface in which additional chats are added in the chat panel 404. For example, the workflow copilot 140 may receive user chats requesting modifications to the sketch illustrated in the workflow panel 402. Based on the user inputs in the chat panel 404, the workflow copilot 140 may update one or more elements of the sketch in the workflow panel 402. For example, the portions 412 and 414 are distinguished with a distinct outline, background, and/or text to indicate that the corresponding steps of the sketch have been updated by the workflow copilot 140.

FIG. 4C illustrates an example graphical interface in which additional chats are shown in the chat panel 404. For example, the workflow copilot 140 may request that the user provide connection details for one or more of the steps of the workflow/sketch displayed in the workflow panel. Furthermore, another element of the sketch in the workflow panel 402 is illustrated as having been updated based on the interaction with the user in the chat panel 404.

FIG. 4D illustrates an example graphical interface in which a configuration panel 406 is displayed alongside the workflow panel 402 and the chat panel 404. In the depicted example, some steps are illustrated as being converted from a sketch format to a workflow format (e.g., as they are being processed, configured, or solved), as illustrated at the element 432. The element 432 may be illustrated with more colors, definition, or a temporary appearance, such as with a blank box, gradient, or another format. The in-process format may be an interim format after a sketch format, which graphically indicates that the workflow copilot 140 is converting the sketch step to a workflow step, as noted elsewhere herein.

FIG. 4D also illustrates a solved workflow element 434, which may provide a further distinguished format to indicate that the step has been solved, configured, is being reviewed, was previously reviewed, or another status. As shown in the example, additional concrete details may be displayed, such as those that have been solved or otherwise configured. Additionally, the configuration panel 406 may be displayed and provide configuration and/or review for one or more of the workflow (or sketch) elements displayed in the workflow panel 402.

FIG. 4E illustrates an example graphical interface in which some steps of the sketch are displayed alongside some steps of a solved workflow (e.g., converted from sketch steps). As illustrated in the example, a first graphical element 442 and second graphical element 444 are shown as being in process of being solved by the workflow copilot 140.

A third, fourth, and fifth graphical element 446, 448, and 450 are displayed as solved/converted workflow steps. The fourth element 448 and fifth element 450 also include a graphical flag indicating that they are pending review. Selection of one of these elements may display their configuration or details in the configuration panel 406, and/or configuration or review in the chat panel 404.

A sixth, seventh, and eighth graphical element 452, 454, and 456 representing sketch elements that have not yet been solved or converted into workflow elements are also shown.

Further implementations and details of the interfaces shown in FIGS. 4A-4E are additionally or alternatively described and illustrated below, for example, in reference to FIGS. 5-29.

FIG. 5 illustrates an example graphical user interface in which a user sends a message via a chat interface (e.g., in a right bar, column, or panel of the interface) to indicate a desire of the user. While certain layouts and graphical elements are shown, other implementations are possible and contemplated.

In the depicted example, the interface includes a workflow panel 502 and a chat panel 504. In the example, the workflow panel 502 is shown blank or with a placeholder text (e.g., “use workflow copilot 140 to get started, or build your own”, links, images, etc.).

In the example, the workflow panel 502 is shown with stippling while the chat panel 504 is shown with a colored background. Each of these panels may vary depending on the state of the system. For instance, the workflow panel 502 is stippled or may otherwise look like a note pad to emphasize that it is in a blank or sketch state. The chat panel 504 may have certain colors (blue is shown), which may be distinct from the message boxes to or from the workflow copilot 140. The colors, differences between the colors, or other aspects may vary to convey to the user whether the workflow copilot 140 is processing a response, generating a sketch, generating a workflow, awaiting user input, or in another state.

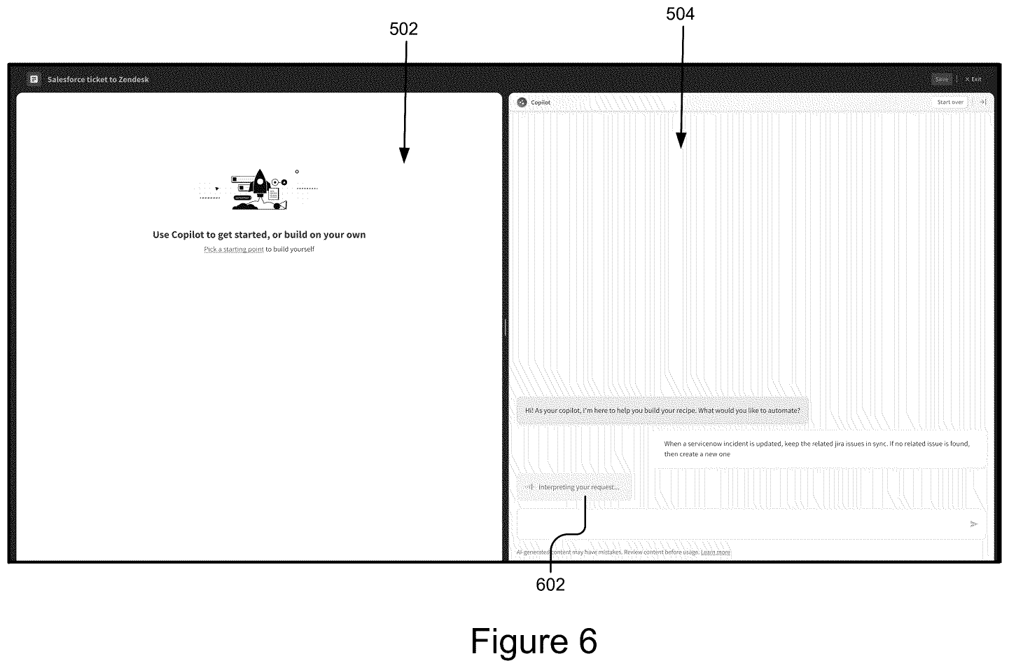

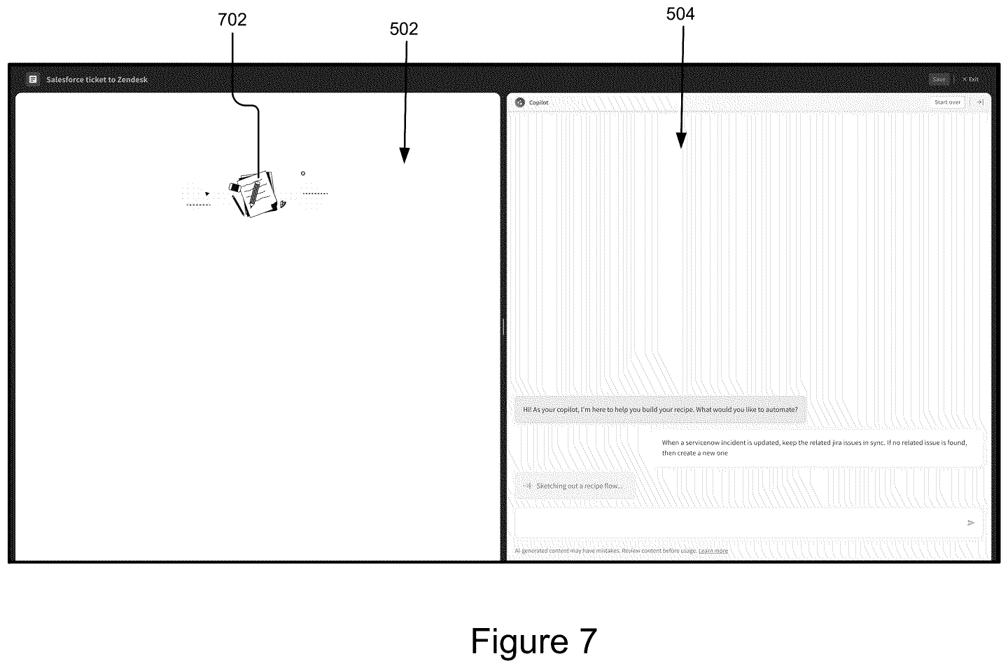

FIG. 6 illustrates an example graphical user interface in which an AI assistant indicates that it is interpreting the request in an in-process chat bubble 602 in the chat panel 504. Additionally, in the example graphical user interface of FIG. 7 may also indicate in an image 702 or other graphical element that the workflow copilot 140 is in the processes sketching out a recipe flow in the workflow panel 502.

FIG. 8 illustrates an example graphical user interface in which the workflow copilot 140 returns a sketch of the workflow in the workflow panel 502 (e.g., in a left bar, column, or panel of the interface). The chat panel 504 also indicates that the workflow copilot 140 has built out a sketch.

In the example of FIG. 8, details are included in the sketch except the steps to accomplish the user's objective and notes about what each step will do, although other implementations are possible and contemplated herein. As illustrated, a sketch may have a graphical style on the canvas indicating that it is a sketch, such as the appearance of a drawing, which allows the AI assistant to indicate, in a simple to understand way, what it believes the user's intent for a workflow/recipe/automated task might be. In some implementations, the elements of the sketch may be unclickable flowchart elements, though in other implementations, they may be clickable, draggable, or otherwise editable.

As shown in the example drawing 802, which represents the sketch. The sketch may include a flowchart that may be displayed in a rough or light colored way with one or more triggers or conditions (e.g., displayed in boxes), one or more actions (e.g., displayed in boxes), and connections (e.g., displayed in lines or arrows) to indicate a flow or logic. In the depicted example, the workflow panel 502 has a background that makes it look unfinished or like a note pad with texture, lines, a grid, or stippling. Similarly, the drawing 802 of the sketch is displayed in grayscale, potentially with lower contrast or lighter shades of elements.

In the example, the sketch indicates “fetch updated incidents from ServiceNow via webhook,” as a trigger and several dependent actions (e.g., “Search for Jira issues that match the description of the updated ServiceNow incident”) on the trigger to accomplish a task (e.g., “when a ServiceNow incident is updated, keep the related Jira issues in sync. If no related issue is found, then create a new one”).

The workflow copilot 140, because it is generating an outline of steps to be performed rather than, for instance, computing the details of the operations (e.g., API calls to get schema or other assets from different services, etc.), may generate the sketch in a fraction of the time that it would have taken to generate an entire workflow/recipe.

FIG. 8 illustrates an example graphical user interface in which the user asks the workflow copilot 140 to update the sketch as needed. For instance, the chat message and holding/in process messages may be shown in the chat panel 504. In some implementations, the interface may show an animation or other information in the workflow panel 502 for the entire sketch or steps thereof. In some cases, it may revert to a generating image or moving graphic (e.g., a graphical image format image, video, etc.) or otherwise indicate the changes. In some cases, it may directly show the changes on the sketch drawing as they are being performed/changed.

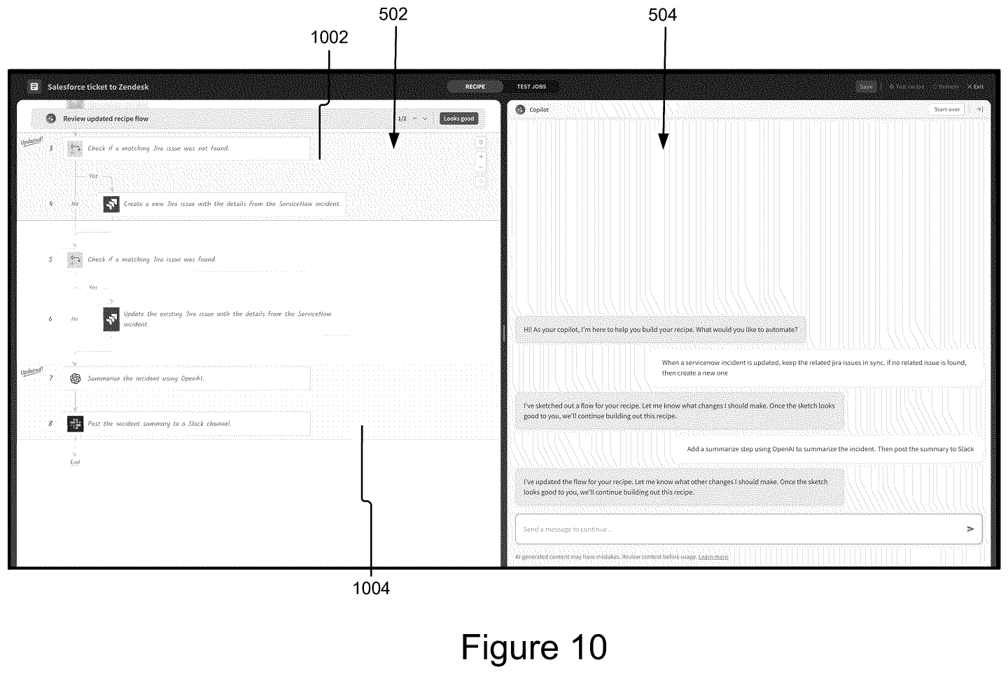

FIG. 10 illustrates an example graphical user interface in which the workflow copilot 140 may update the sketch based on the user's direction and showcase the changes to the sketch in the user for review in the workflow panel. For instance, if the workflow copilot 140 has not interpreted the user's intent correctly, the user may provide input via the conversational interface to update the sketch and correct the copilot's understanding of the intent and/or provide additional clarity or information. For instance, in the example, the user has requested that the workflow copilot 140 add a summarizing step from another service via a chat in the chat panel 504.

In some implementations, the workflow copilot 140 may highlight a portion of the canvas or workflow panel 502 around the sketch to indicate which portion(s) of the sketch were modified. For instance, two sections 1002 and 1004 of the workflow panel 502 are shown with a background that has been modified (illustrated in a darker shade of gray) and/or a text (e.g., “updated!”) or other graphical element to draw distinction to the changes to the sketch. Accordingly, the sketch can be iteratively updated or modified by the user.

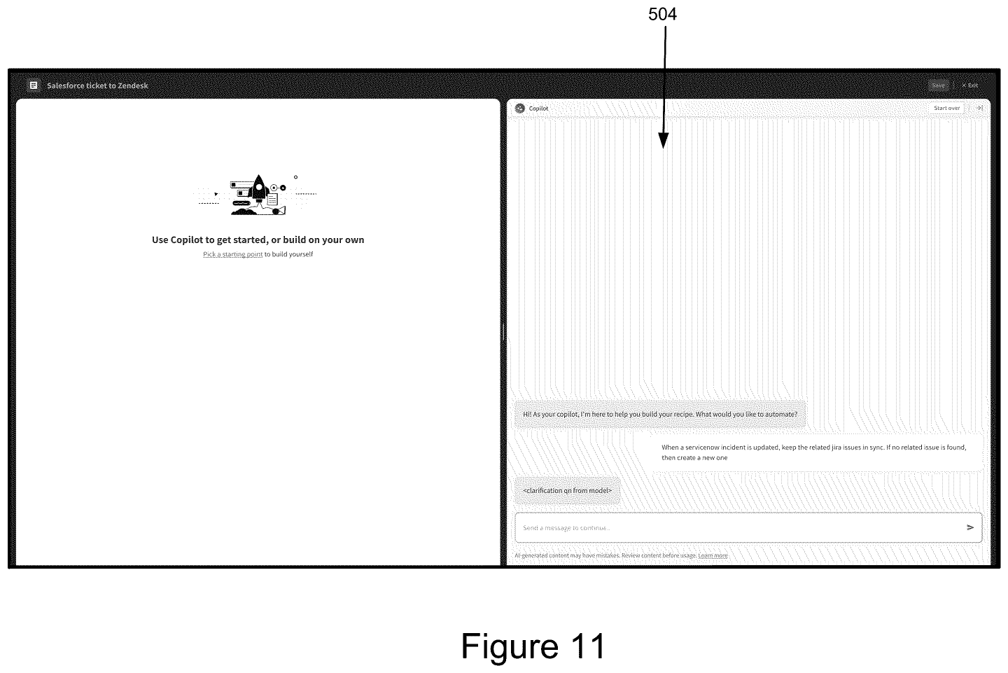

FIG. 11 illustrates an example graphical user interface in which the workflow copilot 140 is requesting clarification from the user. For example, if an aspect of the sketch to be modified (or otherwise generated) is unclear, the workflow copilot 140 may request clarification from the user in the chat panel 504.

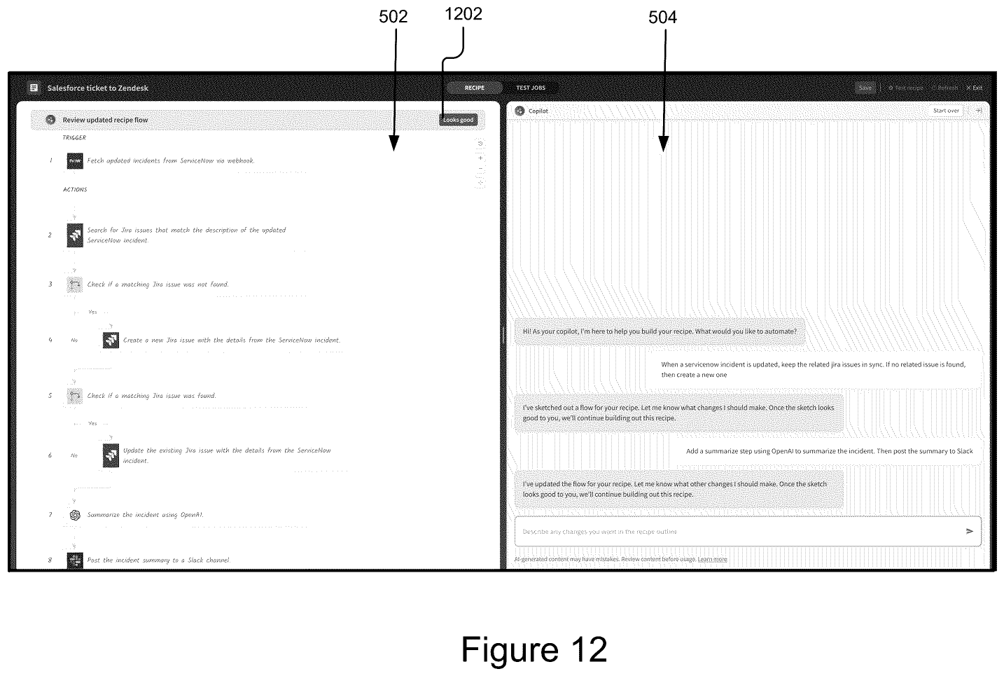

FIG. 12 illustrates an example graphical user interface in which the sketch is updated in the workflow panel 502. Additionally, in some implementations, the workflow copilot 140 may display a chat response indicating that the update has been performed and/or which updates were performed in the chat panel 504. As illustrated, the graphical panel 502 may include a graphical button 1202 that the user may select to indicate confirmation of the sketch (e.g., “Looks good”).

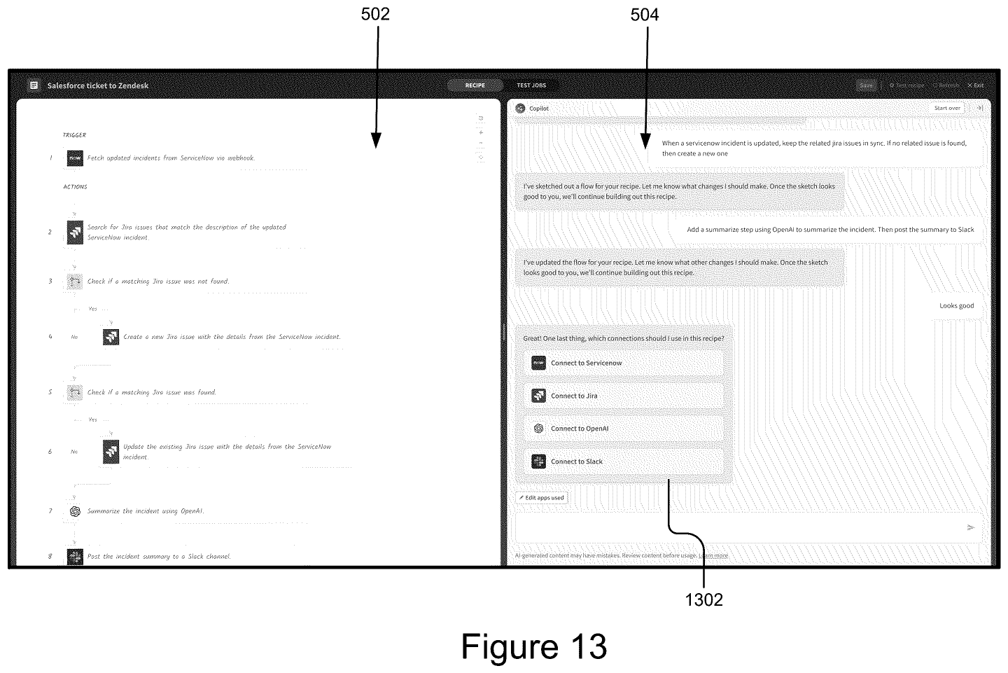

FIG. 13 illustrates an example graphical user interface in which a user has provided confirmation that the sketch is what the user desires, and the workflow copilot 140 asks for connections to the applications used in the workflow from the user. For example, the workflow copilot 140 may request, in the chat interface in the chat panel 504, that the user indicate which connections to provide and/or details about the connections. In some cases, this process may include selecting previously defined connections (e.g., credentials, authentication details, APIs, etc.) or providing new connection details for one or more of the sketches in the sketch. In some cases, these details may be determined as each step is solved, at runtime, or otherwise.

As shown in FIG. 13, during this process, the workflow panel 502 may remain unchanged or it may highlight which operation(s) of the sketch uses the requested connection. Also, as shown in the chat panel 504, the workflow copilot 140 may display a chat message 1302 requesting connection details and which may either illicit a user text input or may include links or other interface elements that may be selected to provide the inputs. In some implementations, the message(s) 1302 may request connections for multiple steps in the workflow, such as where multiple or different connections are used (e.g., a first connection for ServiceNow™ and a second connection for Slack™).

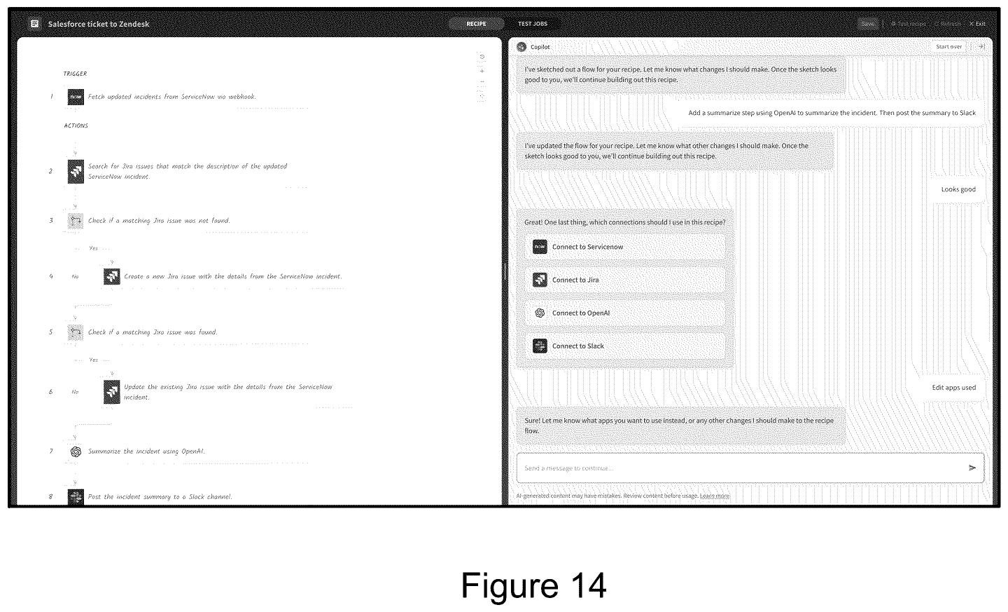

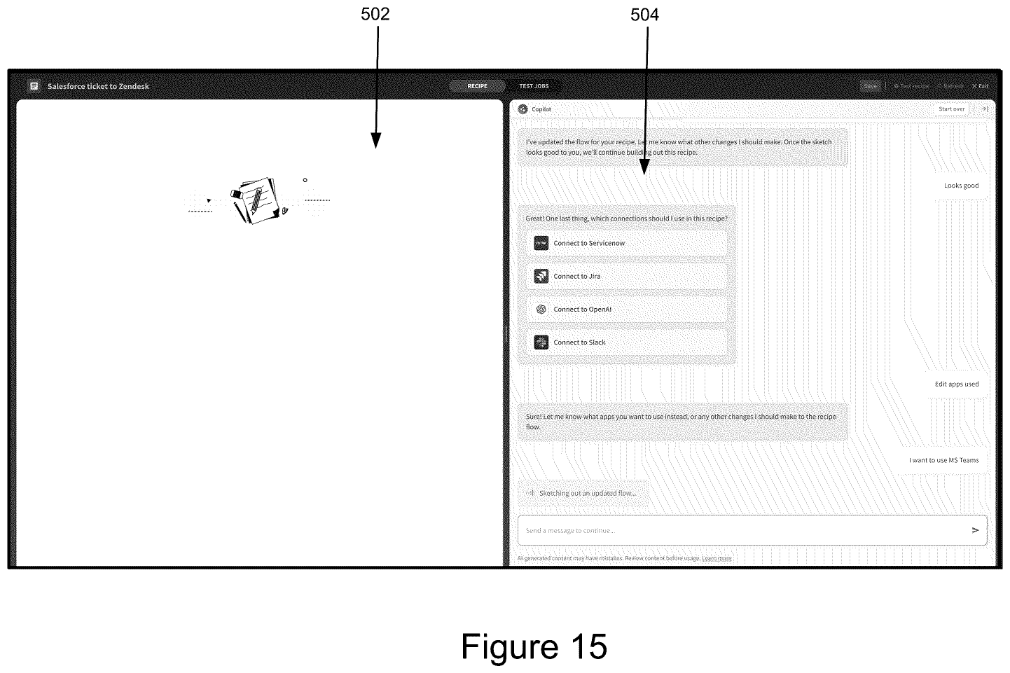

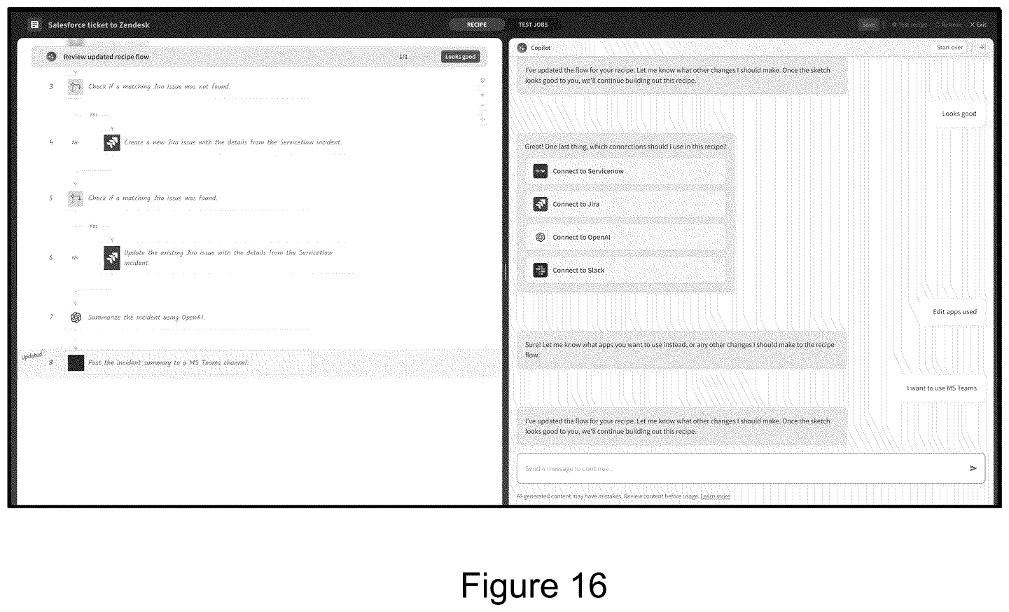

In some cases, the workflow copilot 140 may allow the user to edit the connection and/or apps used (e.g., by selecting Teams™ instead of Slack™). FIG. 14 illustrates an example graphical user interface in which a user chats with the AI assistant to modify which apps used or other details, and the workflow copilot 140 requests additional information for which apps to edit or use. FIG. 15 illustrates an example graphical user interface in which the workflow copilot 140 indicates in the chat panel 504 that it is updating the sketch for the new app requested to be used, and it may indicate, in the workflow panel 502 that the sketch is being updated, as noted elsewhere herein. FIG. 16 illustrates an example graphical user interface in which the sketch in the canvas is updated to use the user-requested modification in a similar way to that described above.

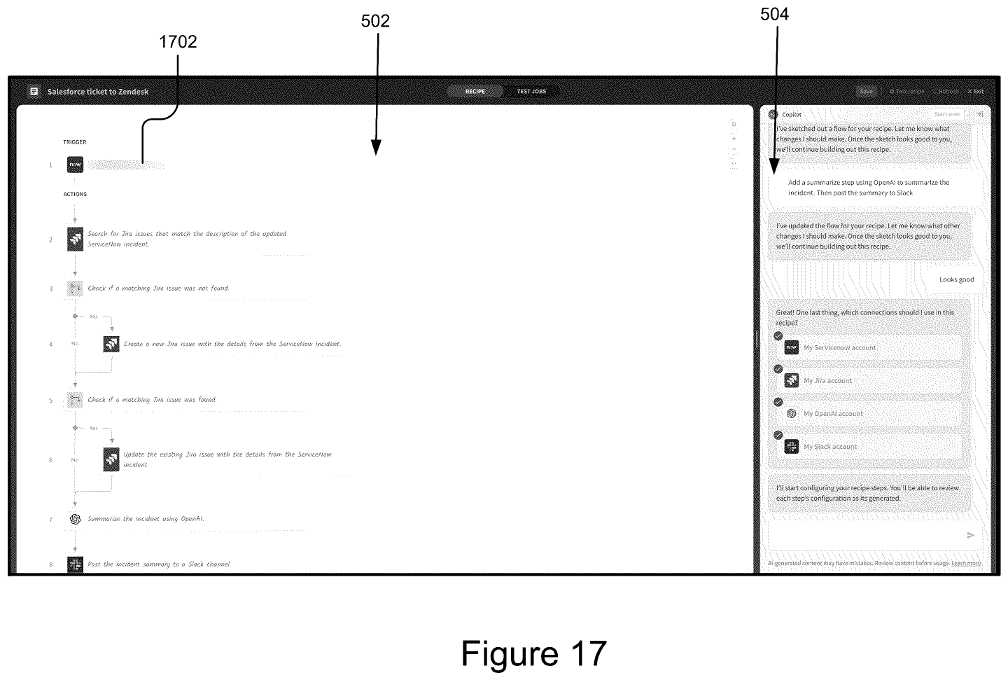

FIG. 17 illustrates an example graphical user interface in which the workflow copilot 140 receives the connections from the user and begins building a workflow incrementally. In some instances, the relative sizes of the workflow panel 502 and the chat panel 504 may be automatically resized (e.g., once the sketch solving process begins) or based on user input.

In some implementations, a step being finalized/computed (e.g., by the third LLM) may be modified in the sketch. For example, a graphical element 1702 in the sketch may be updated to show that it is in flux or otherwise being updated. As illustrated in the example, a trigger is being determined (e.g., via an animation at the trigger). In some implementations, conversion of the sketch to a workflow may be compartmentalized as its components are determined or represented. The workflow copilot 140, as noted above, may determine each dependent step consecutively, which may be iteratively shown in the user interface.

As shown, the graphical element 1702 may include an icon indicating a service, application, or other aspect of the sketch that is being updated. As shown in the example, it is updated to be in color, thereby indicating a connection, a configuration of a portion of the step, or otherwise. Similarly, the text, box, or other aspects of the component of the sketch being solved may be grayscaled, include a gradient, become more transparent, or otherwise indicate that the step is in process of being solved, computed, coded, or otherwise resolved.

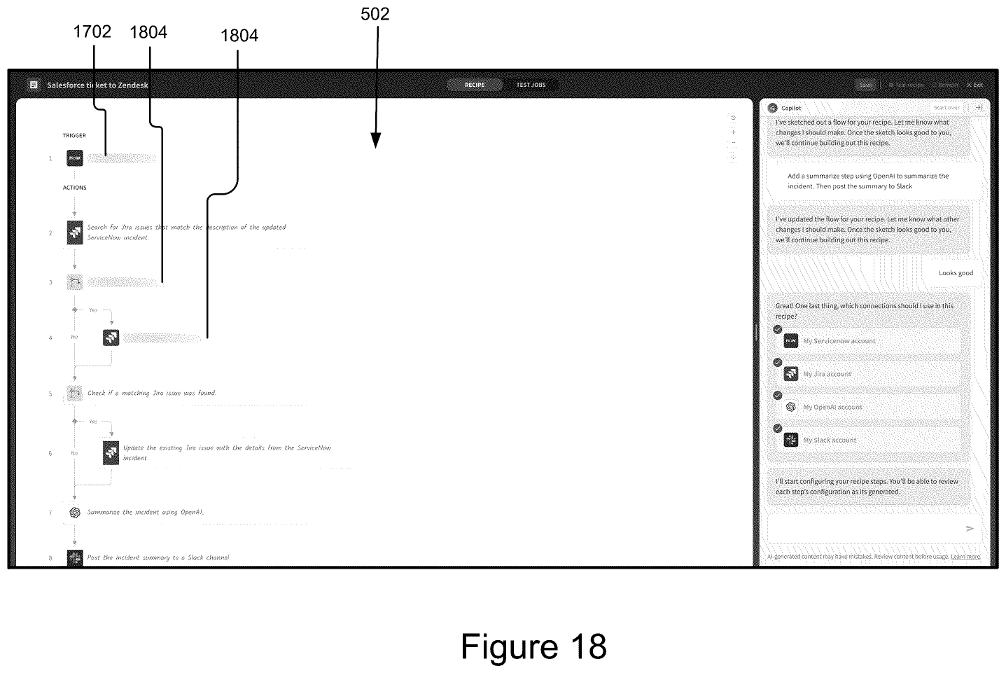

FIG. 18 illustrates an example graphical user interface in which multiple steps of the sketch are shown as being updated/determined/computed in the workflow panel 502. For example, the graphical elements 1702, 1804, and 1806 for some steps are shown indicating that they are being updated. For instance, the operations may be determined in order, based on response times from the related services, or based on dependencies/interrelated data, etc., as noted elsewhere herein.

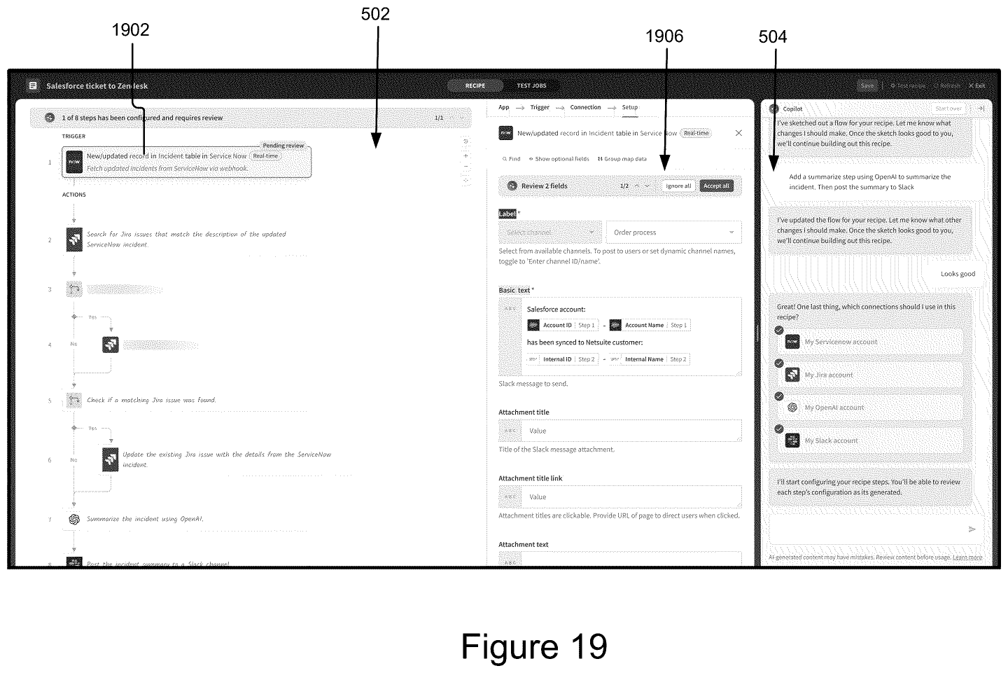

FIG. 19 illustrates an example graphical user interface in which the workflow copilot 140 reports back to the user when each step of the workflow is built and allows the user to review it, for instance, while the copilot continues building the remainder of the workflow based on the sketch. In some implementations, the interface may be updated to display the initial sketch step description as a comment for each workflow step of the workflow/recipe. For instance, the workflow copilot 140 may continue to determine other concurrent processes that are not dependent on the trigger itself. Once a step is ready, the canvas in the workflow panel 502 may be updated to modify the representation of the step, so the user can see the workflow being built based on, in place of, or over the top of the sketch.

As illustrated in the example, a graphical element 1902 is shown indicating that the step has been solved. In some instances, when a step of a sketch is replaced with a step of the workflow, the workflow step's graphical element may be selectable to display the third panel to configure the step or view its details.

The updated graphical element 1902 is shown with a colored icon, icon, and portions of the text to differentiate it from the background of the remainder of the unsolved sketch in the workflow panel 502. Additionally, the background of the box for the step represented by the element 1902 is updated to be opaque and colored, which further differentiates it as solved. Finally, as illustrated in the depicted example, textual details of the step may be shown at the element 1902. For example, it indicates that the trigger is a “New/updated record in Incident table in Service Now (Real-time). Fetch updated incidents from ServiceNow via webhook.” The element 1902 may also indicate that it is pending review, for example, by the user.

As illustrated in FIG. 19, in some implementations, the graphical user interface may display or expand a third graphical panel or configuration panel 1906 that displays details of one or more of the steps. For instance, when a step is generated (e.g., that requires user input or configuration, or to allow user review), the interface may automatically, or based on manual input, display details of the step and await user input. The configuration panel 1906 may indicate which fields or steps are ready for review and allow the user to step through the fields, modify them, ignore them, or accept them. Although various implementations are possible, the depicted example allows the user to review or modify the solved component of the workflow. In the example, the background, outline, and/or graphical elements of the configuration panel 1906 may be distinguished from the workflow panel 502 and chat panel 504.

As described in further detail elsewhere herein, a sketch and/or individual elements in the sketch may be rough and/or lack sufficient detail for them to be executed (e.g., by the workflow copilot 140). In some implementations, the solved workflow element may be more concrete and/or detailed, for example, a solved workflow step may include code, defined input/output schemas, or other details that allow the workflow copilot 140 or another program to execute that step. In some implementations, this lower level of detail and this greater level of detail may be represented in the recipe sketch and the solved workflow/workflow elements, as noted elsewhere herein.

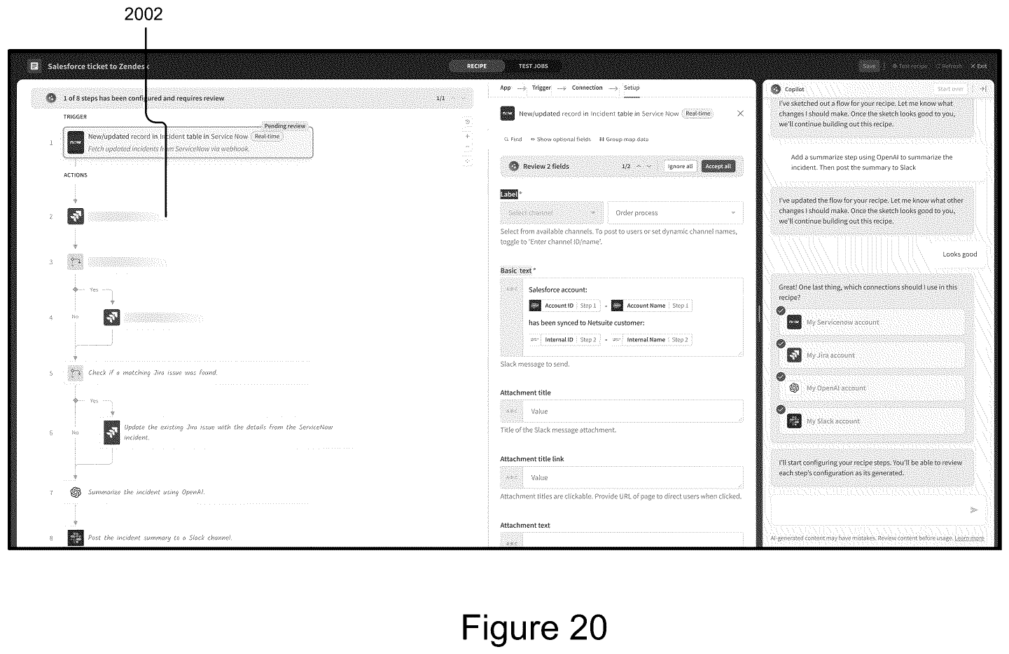

FIG. 20 illustrates an example graphical user interface in which another one of the sketch steps is indicated as being generated/computed at the graphical element 2002, thereby indicating the parallel processing/solving by the workflow copilot 140, for example, using communications with an LLM (e.g., the third LLM referenced elsewhere herein). For instance, a step that is dependent on the trigger may be computed and the interface may reflect the processing with a graphical element or an animation. In some cases, solving a certain step may wait for a previous step to be confirmed or configured by the user.

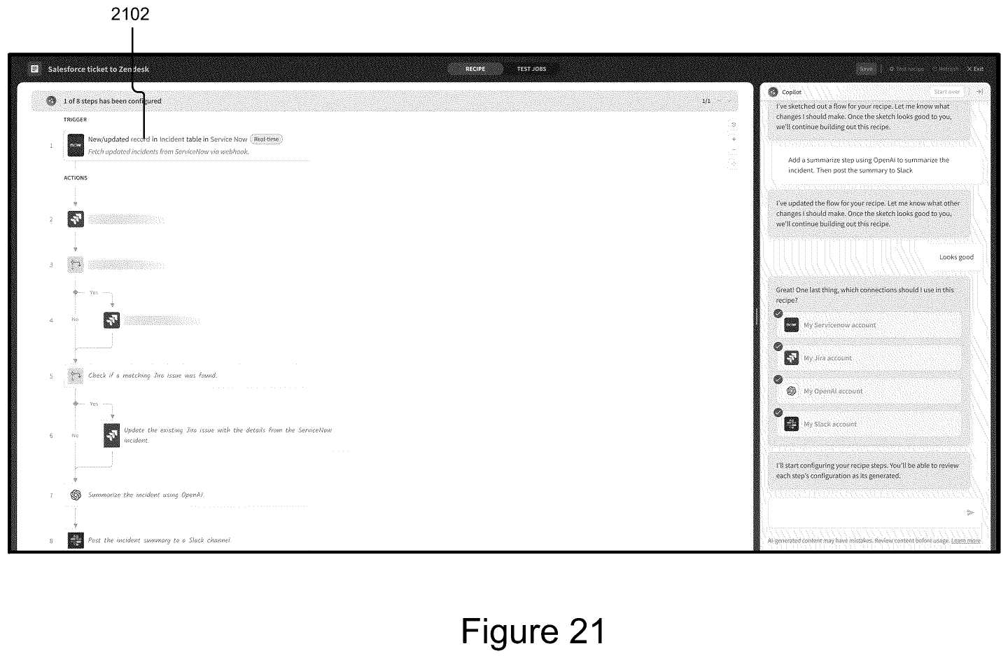

FIG. 21 illustrates an example graphical user interface in which a trigger step has been reviewed, for example, by the user, and the corresponding configuration/review panel 1906 has been closed. In some cases, the configured/reviewed step in the workflow panel 502 may be graphically updated to indicate that it has been configured or reviewed. For instance, the graphical element 2102 may replace or represent an updated version of the element 1902. In the depicted example, the color and/or shade of the box and/or outline may be updated to indicate that it has been reviewed. Additionally, the element 2102 may be shown with a solid background and/or outline, color, and/or other aspects to indicate that it has been solved/is no longer a sketch element.

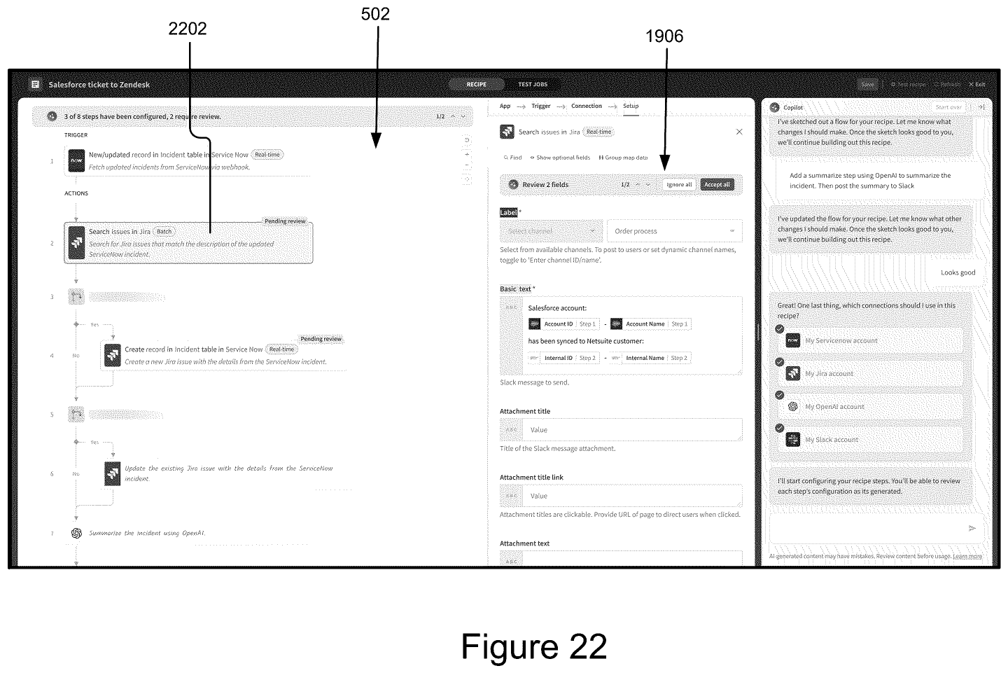

FIG. 22 illustrates an example graphical user interface illustrating the continuation of the process as the workflow as generated by the workflow copilot 140. In some instances, the user may choose to review steps (e.g., in the configuration panel 1906 and/or workflow panel 502) as it is built, or the user may review the entire workflow when it is generated. For instance, a second step in the workflow is shown being reviewed by the user in a configuration/review panel 1906. Additionally, another graphical element 2202 is graphically differentiated to indicate that it is pending review and being reviewed (e.g., in the configuration panel 1906).

Accordingly, the user may know when steps are being solved and finished, such as where the workflow copilot 140 and interface allow the user to review one or more of the steps, for example, as they are solved by the workflow copilot 140 (e.g., by the third LLM).

As noted above, in some implementations, the steps may be solved in order of their dependencies. For instance, steps that aren't dependent on another step being solved may be solved first while steps that are most dependent (e.g., a last step that uses information from one or more previous steps) may be solved later or last. For instance, the AI assistant may use the sketch and/or workflow steps to determine a sequence for solving the steps, which may be sequentially or otherwise.

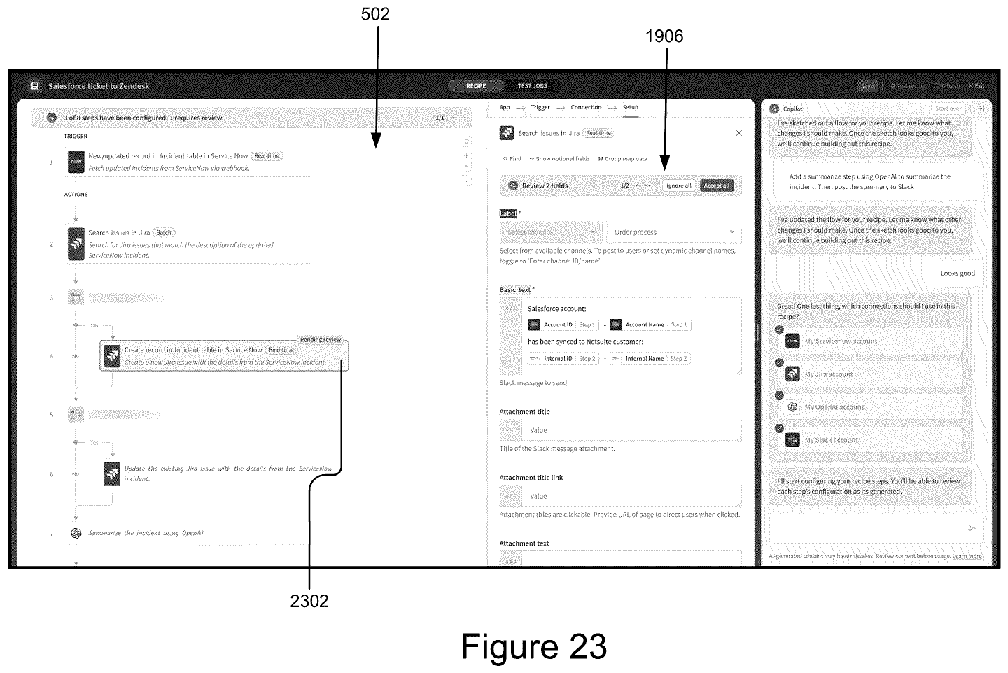

FIG. 23 illustrates an example graphical user interface in which another step is illustrated as being solved. The interface shows that three of eight steps are configured, and one requires review. As illustrated in the workflow panel 502, a different graphical element 2302 is shown indicating that it is being reviewed/configured (e.g., in the configuration panel 1906).

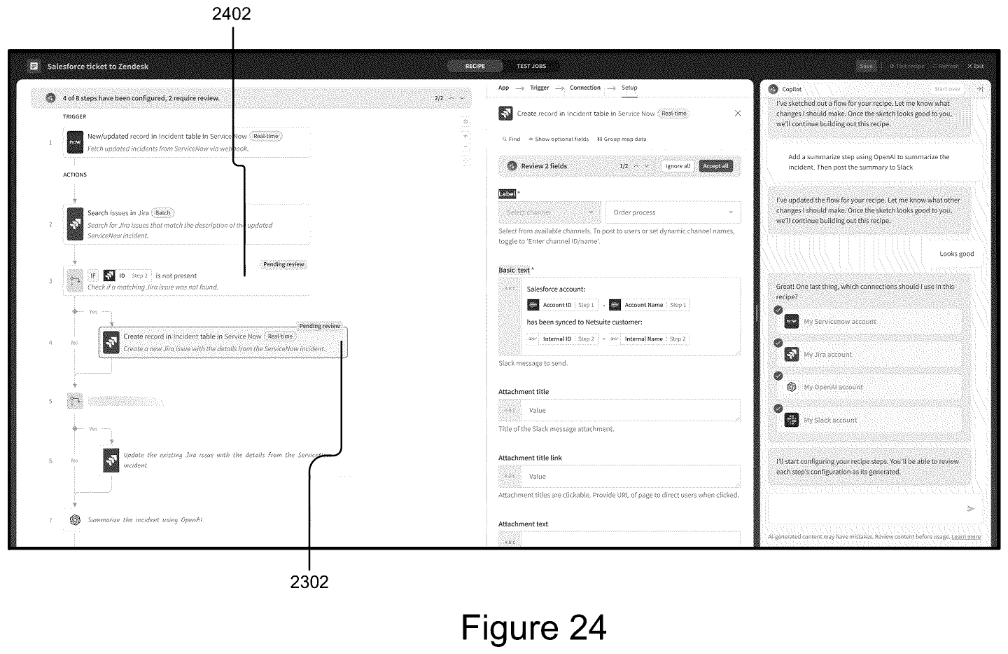

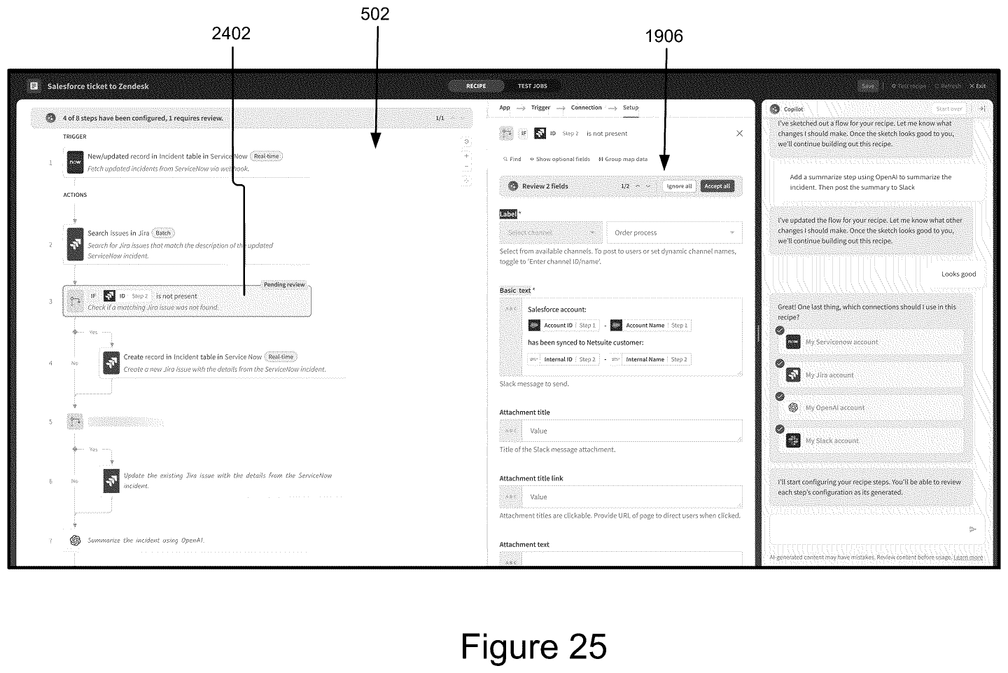

FIG. 24 illustrates an example graphical user interface in which a fourth step has been solved as shown in the graphical element 2402. In the depicted example, the graphical element 2302 is still being reviewed and is indicated as being reviewed. As shown in the example, the element 2402 indicates that an issue was not found or is not present, which may request additional processing by the workflow copilot 140 and/or configuration by the user. FIG. 25 illustrates the example graphical user interface where the workflow panel 502 indicates that the step represented by the graphical element 2402 is being reviewed/configured, for example, in the configuration panel 1906. For instance, as a sequence is completed or a step is done and solved, the interface and AI assistant may allow the user to review the workflow as it is still being built.

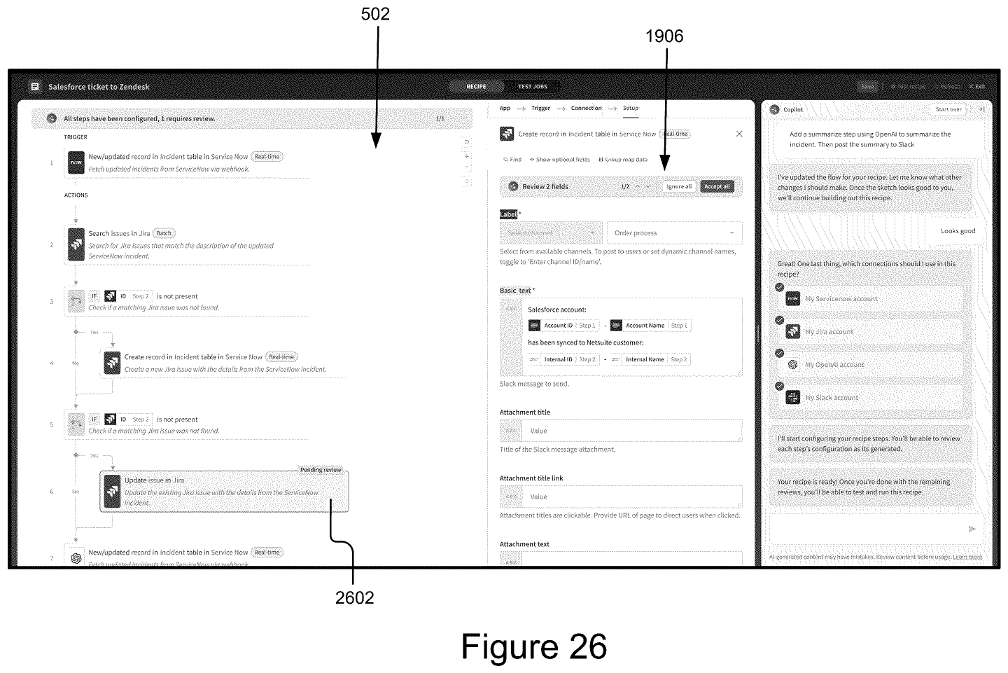

FIG. 26 illustrates an example graphical user interface in which all steps of the sketch have been solved and/or configured, but one step is pending review by the user. The element 2602 is graphically depicted as being reviewed (e.g., in a configuration panel 1906).

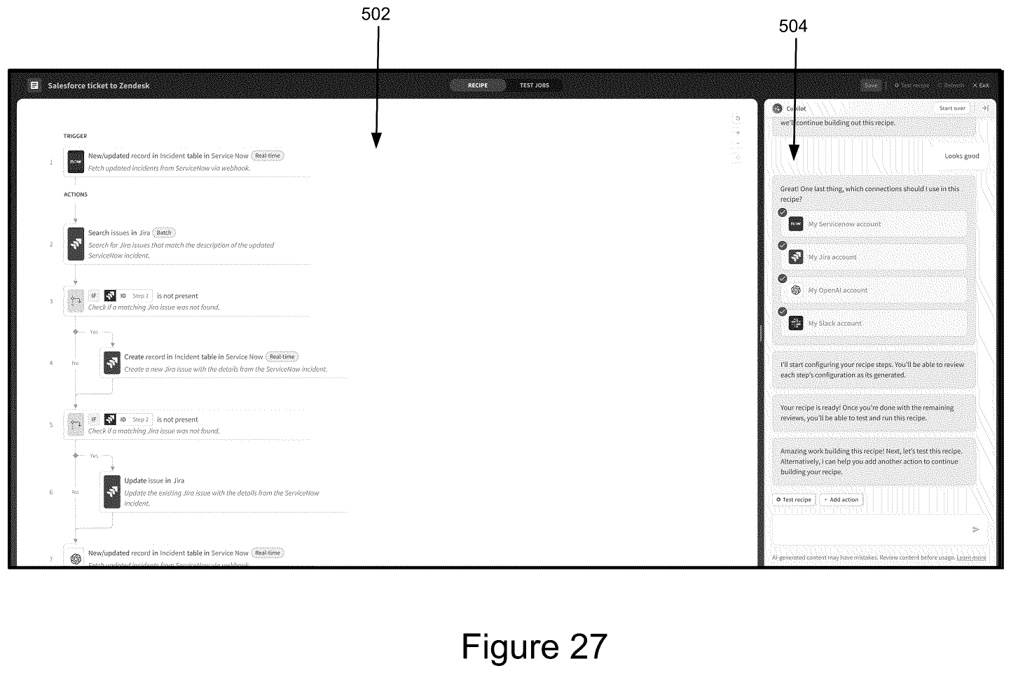

FIG. 27 illustrates an example graphical user interface in which the workflow has been fully built, and the sketch has been replaced by the workflow in the workflow panel 502. In some instances, the workflow elements may include the sketch elements/steps as comments on the workflow elements/steps. In some implementations, once the last step has been solved, configured, and/or reviewed, the configuration panel 1906 may automatically close.

As illustrated, the AI assistant may suggest and/or facilitate testing of the workflow recipe, or it may allow the user to add another operation or otherwise modify the workflow (e.g., add a sketch element or workflow element, etc.). For instance, in the chat panel 504, the workflow copilot 140 may output a message indicating that the recipe/workflow is ready. It may also suggest and/or facilitate testing the workflow, and/or it may receive input and, based on the input, further modify the workflow.

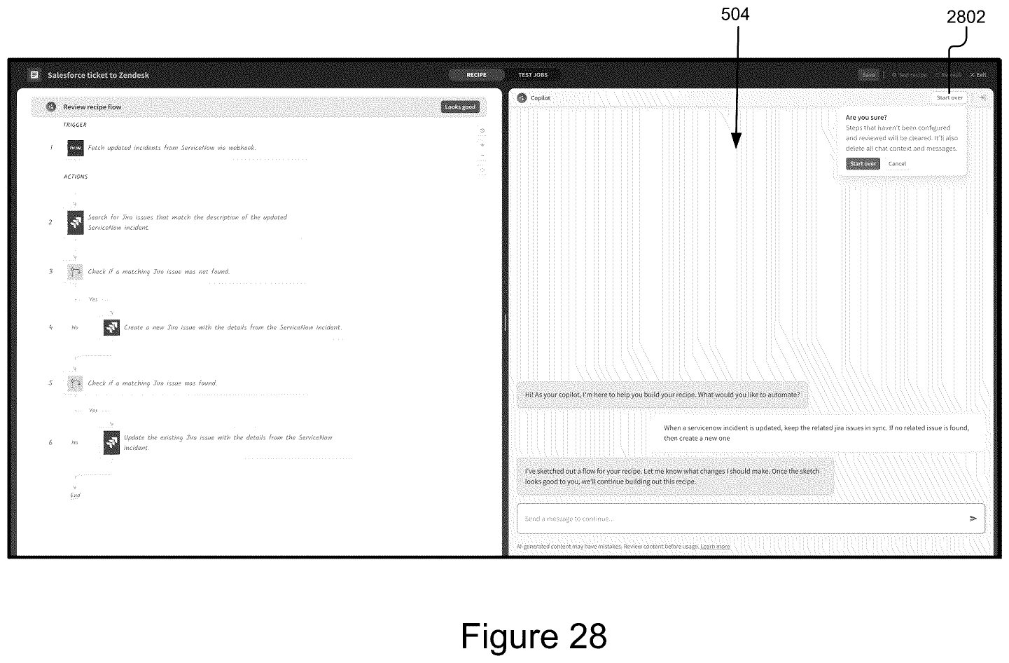

FIG. 28 illustrates an example graphical user interface in which a user has selected a graphical element/button 2802, which may be displayed in the chat panel 504 or elsewhere in the interface. The graphical element 2802 may indicate and instruct the workflow copilot 140 to start over. For instance, this example interface and graphical element may correspond to or be displayed after the example of FIG. 8 or at another point.

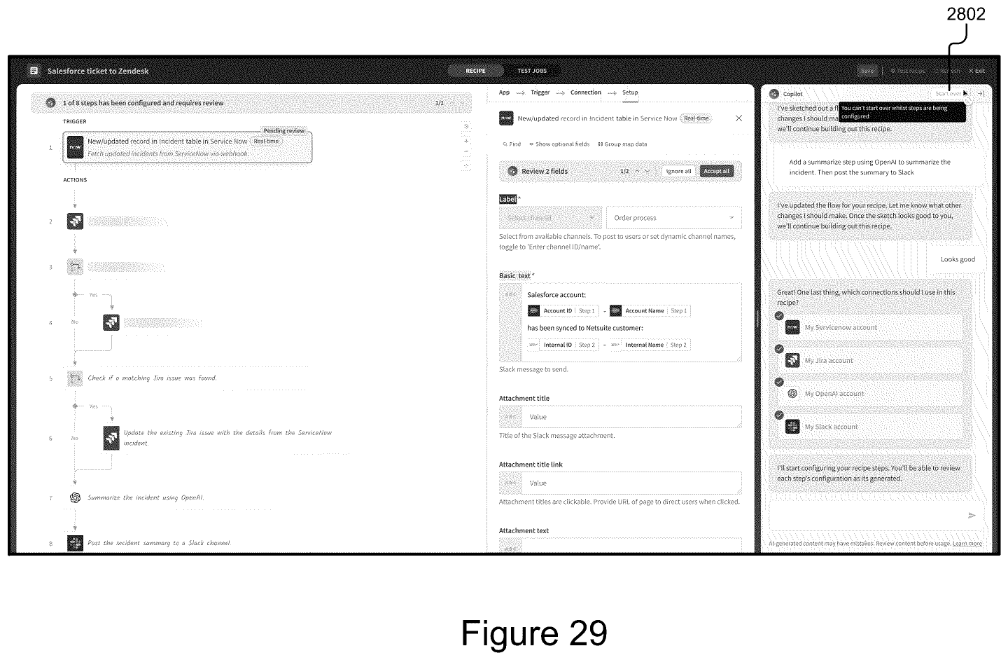

FIG. 29 illustrates an example graphical user interface in which a user has selected a graphical element/button 2802 indicating to start over, but the workflow copilot 140 indicates in the interface that the process cannot be started over while steps are being configured or the workflow copilot 140 is processing.

In the above description, for purposes of explanation, numerous specific details are set forth in order to provide a thorough understanding of the present disclosure. However, it should be understood that the technology described herein can be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services. Thus, it should be understood that a variety of different system environments and configurations are contemplated and are within the scope of the present disclosure. For instance, various functionality may be moved from a server to a client, or vice versa and some implementations may include additional or fewer computing devices, services, and/or networks, and may implement various functionality client or server-side. Further, various entities of the described system(s) may be integrated into to a single computing device or system or additional computing devices or systems, etc. In addition, while the system depicted herein provides an example of an applicable computing architecture, it should be understood that any suitable computing architecture, whether local, distributed, or both, may be utilized in the system.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to a computing device and/or other apparatus for performing the operations herein. This computing device may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in executable software, which includes but is not limited to an application, firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Communication unit(s) (e.g., network interfaces, etc.) may also be coupled to the system to enable the data processing system to become coupled to other data processing systems, storage devices, remote printers, etc., through intervening private and/or public networks, such as the network 102.

Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a collection of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment.

What is claimed is:

1. A computer-implemented method comprising:
receiving, by one or more processors, one or more user prompts in a conversational interface;
determining, by the one or more processors, an intent of a user based on the one or more user prompts using one or more artificial intelligence (“AI”) models;
determining, by the one or more processors, to generate a recipe sketch based on the intent of the user, the recipe sketch including one or more triggers and a set of rough automated operations configured to accomplish a task;
transmitting, by the one or more processors, a sketch request to the one or more AI models to generate the recipe sketch;
receiving, by the one or more processors, the recipe sketch from the one or more AI models;
providing, by the one or more processors, a graphical user interface displaying a graphical representation of the recipe sketch to the user;
receiving, by the one or more processors, a user input modifying the recipe sketch;
transmitting, by the one or more processors, the user input modifying the recipe sketch to the one or more AI models;
receiving, by the one or more processors, a modified recipe sketch from the one or more AI models based on the user input modifying the recipe sketch;
based on receiving a second user input confirming the modified recipe sketch, transmitting, by the one or more processors, at least a portion of the modified recipe sketch to the one or more AI models with a request to generate a set of executable operations for the modified recipe sketch; and
updating, by the one or more processors, the graphical user interface including modifying the graphical representation to indicate the generated set of executable operations.

2. A computer-implemented method comprising:
generating, by one or more processors, a recipe sketch based on an intent of a user, the recipe sketch including one or more triggers and a set of rough automated operations configured to accomplish a task;
providing, by the one or more processors, a graphical user interface displaying a graphical representation of the recipe sketch to the user;
based on a confirmation that the recipe sketch represents the intent of the user, generating, by the one or more processors, a set of executable operations based on the set of rough automated operations of the recipe sketch; and
updating, by the one or more processors, the graphical user interface including modifying the graphical representation of the recipe sketch to indicate the generated set of executable operations.

3. The computer-implemented method of claim 2, wherein:
the recipe sketch includes an outline of a workflow of the one or more triggers and the set of rough automated operations to perform the task.

4. The computer-implemented method of claim 2, wherein modifying the graphical representation of the recipe sketch to indicate the generated set of executable operations includes:
replacing each of a first set of graphical elements with a second set of graphical elements in the graphical user interface iteratively as each of the set of executable operations is generated, the first set of graphical elements representing the set of rough automated operations, the second set of graphical elements representing the generated set of executable operations.

5. The computer-implemented method of claim 4, wherein:
the first set of graphical elements representing the set of rough automated operations includes a first level of detail about the set of rough automated operations; and
the second set of graphical elements representing the generated set of executable operations include a second level of detail about the set of executable operations, the second level being a greater level of detail than the first level.

6. The computer-implemented method of claim 5, wherein:
the set of rough automated operations lack sufficient detail to be performed by the one or more processors; and
the generated set of executable operations include sufficient detail to be performed by the one or more processors.

7. The computer-implemented method of claim 2, further comprising:
transmitting, by the one or more processors, a sketch request to one or more artificial intelligence (AI) models to generate the recipe sketch; and
receiving, by the one or more processors, the recipe sketch from the one or more AI models.

8. The computer-implemented method of claim 2, further comprising:
receiving, by the one or more processors, a user input modifying the recipe sketch;
transmitting, by the one or more processors, the user input modifying the recipe sketch to one or more artificial intelligence (AI) models; and
updating, by the one or more processors, the graphical representation of the recipe sketch based on a modification of the recipe sketch by the one or more AI models.

9. The computer-implemented method of claim 2, further comprising determining the intent of the user to create the recipe sketch including:
receiving, by the one or more processors, one or more text prompts from the user in a conversational interface; and
inputting, by the one or more processors, the one or more text prompts from the user into one or more artificial intelligence (AI) models.

10. The computer-implemented method of claim 2, further comprising:
receiving, by the one or more processors, a modified recipe sketch from one or more artificial intelligence (AI) models based on a user input modifying the recipe sketch;
updating, by the one or more processors, the graphical user interface displaying the graphical representation of the recipe sketch based on the modified recipe sketch; and
based on receiving a user input confirming the modified recipe sketch, transmitting, by the one or more processors, at least a portion of the modified recipe sketch to the one or more AI models with a request to generate the set of executable operations for the modified recipe sketch.

11. The computer-implemented method of claim 2, further comprising:
determining the intent of the user based on one or more user prompts using one or more artificial intelligence (AI) models includes:
transmitting the one or more user prompts to a first large language model; and
receiving a response from the first large language model indicating that the user is requesting to generate a workflow for automating the task.

12. The computer-implemented method of claim 11, further comprising:
transmitting a sketch request to generate the recipe sketch to a second large language model, the sketch request reflecting the one or more user prompts.

13. The computer-implemented method of claim 12, wherein generating the set of executable operations includes:
transmitting the recipe sketch to a third large language model, the third large language model determining a logic for each of the set of rough automated operations.

14. A system comprising:
one or more processors; and
a computer-readable memory storing instructions that, when executed by the one or more processors, cause the system to perform operations comprising:
generating, by the one or more processors, a recipe sketch based on an intent of a user, the recipe sketch including one or more triggers and a set of rough automated operations configured to accomplish a task;
providing, by the one or more processors, a graphical user interface displaying a graphical representation of the recipe sketch to the user;
based on a confirmation that the recipe sketch represents the intent of the user, generating, by the one or more processors, a set of executable operations based on the set of rough automated operations of the recipe sketch; and
updating, by the one or more processors, the graphical user interface including modifying the graphical representation of the recipe sketch to indicate the generated set of executable operations.

15. The system of claim 14, wherein:
the recipe sketch includes an outline of a workflow of the one or more triggers and the set of rough automated operations to perform the task.

16. The system of claim 14, wherein modifying the graphical representation of the recipe sketch to indicate the generated set of executable operations includes:
replacing each of a first set of graphical elements with a second set of graphical elements in the graphical user interface iteratively as each of the set of executable operations is generated, the first set of graphical elements representing the set of rough automated operations, the second set of graphical elements representing the generated set of executable operations.

17. The system of claim 16, wherein:
the first set of graphical elements representing the set of rough automated operations includes a first level of detail about the set of rough automated operations; and
the second set of graphical elements representing the generated set of executable operations include a second level of detail about the set of executable operations, the second level being a greater level of detail than the first level.

18. The system of claim 17, wherein:
the set of rough automated operations lack sufficient detail to be performed by the one or more processors; and
the generated set of executable operations include sufficient detail to be performed by the one or more processors.

19. The system of claim 14, further comprising:
transmitting, by the one or more processors, a sketch request to one or more artificial intelligence (AI) models to generate a sketch; and
receiving, by the one or more processors, the recipe sketch from the one or more AI models.

20. The system of claim 14, wherein the operations further comprise:
receiving, by the one or more processors, a user input modifying the recipe sketch;
transmitting, by the one or more processors, the user input modifying the recipe sketch to one or more artificial intelligence (AI) models; and
updating, by the one or more processors, the graphical representation of the recipe sketch based on a modification of the recipe sketch by the one or more AI models.
